(19) United States
(12) Patent Application Publication
(10) Pub. No.: US 2022/0027985 A1
(43) Pub. Date: Jan. 27, 2022

(54) INFORMATION PROCESSING DEVICE, INFORMATION PROCESSING SYSTEM, AND INFORMATION PROCESSING METHOD, AND PROGRAM

(71) Applicant: SONY GROUP CORPORATION, TOKYO (JP)

(72) Inventor: REIKO KIRIHARA, TOKYO (JP)

(21) Appl. No.: 17/309,405

(22) PCT Filed: Oct. 10, 2019
(86) PCT No.: PCT/JP2019/039977

§ 371 Date: May 25, 2021

(51) Int. Cl. G06Q 40/02; G08B 3/10; H04N 7/18

(52) U.S. Cl. CPC G06Q 40/025; H04N 7/183; G08B 3/10

(57) ABSTRACT

A configuration of observing a user act in a monitoring region, performing detection of a violative act, and further generating credit information of each user is realized. A monitoring device that acquires detection information of a sensor provided in a monitoring region, and transmits the detection information to a management server, the management server that analyzes a user act in the monitoring region on the basis of the sensor detection information, and a user terminal held by a user are included. The management server determines whether or not a user act falls under a violative act, and in a case where it is determined that a user act is a violative act, notifies the user terminal or the monitoring device. Moreover, the management server executes user identification, and generates and updates credit information of each user on the basis of an observation result of the user act of the identified user.

### TECHNICAL FIELD

The present disclosure relates to an information processing device, an information processing system, and an information processing method, and a program. More specifically, the present disclosure relates to an information processing device, an information processing system, and an information processing method, and a program that perform monitoring of human's entry to a specific location, and human's check-out of goods, and the like.

### BACKGROUND ART

Examples of places available to many people include various places such as an accommodation facility, a working place, an airport, and an art museum. In these places, a region that only a specific permitted person can enter, goods forbidden to be checked out, and the like sometimes exist.

In recent years, a self-propelled robot, a drone, and the like are often used. For preventing collision and the like of such a robot or a drone, a system that uses an imaginary fence called a “virtual fence” is proposed and put in practical use.

This is a configuration of controlling a robot or a drone not to collide by a management system acquiring position information of the robot or the drone, and setting a region in which each robot or drone can move. Note that, as a prior art that discloses the virtual fence, there is Patent Document 1 (Japanese Patent Application Laid-Open No. 2017-225108).

However, the above-described prior art is a configuration of performing movement control of a robot, a drone, and the like that can be controlled from the outside, and is not a configuration of enabling monitoring and control of people in a region into which various people come and out, such as an accommodation facility, a working place, an airport, and an art museum, for example.

A general method of performing human monitoring is a method of checking a captured image of a monitoring camera by a person in a security office. However, such a method involves high cost problem by employing a security guard and the like.

Nowadays, there is an increasing number of accommodation facilities called private residence rental for lending a private house or the like as an accommodation facility. Various people use such a private residence rental facility, but in the house, there are a location that a person is undesired to enter, and goods undesired to be touched. However, a system that captures a behavior of a lodger using a monitoring camera, and always monitors the behavior by a security guard or the like involves high cost, which is problematic.

### CITATION LIST

### Patent Document

Patent Document 1: Japanese Patent Application Laid-Open No. 2017-225108

### SUMMARY OF THE INVENTION

### Problems to be Solved by the Invention

The present disclosure has been devised in view of the above-described problematic point, for example, and aims to provide an information processing device, an information processing system, and an information processing method, and a program that can monitor entry to a specific location, check-out of goods, and the like, and prevent these acts, without directly checking and monitoring a camera captured image and the like by a human.

Moreover, an embodiment of the present disclosure is an information processing device, an information processing system, and an information processing method, and a program that can generate credit information of a human on the basis of information obtained by monitoring processing, and provide the generated credit information to various users.

### Solutions to Problems

The first aspect of the present disclosure is

an information processing device including

a data processing unit configured to analyze a user act on the basis of sensor detection information,

in which the data processing unit determines whether or not a user act falls under a violative act, and

in a case where it is determined that a user act is a violative act, the data processing unit performs notification of a warning.

Moreover, the second aspect of the present disclosure is

an information processing system including

a monitoring device configured to acquire detection information of a plurality of sensors provided in a monitoring region, and transmit the detection information to a management server,

a management server configured to receive sensor detection information from the monitoring device, and analyze a user act in the monitoring region on the basis of the received sensor detection information, and

a user terminal held by a user,

in which the management server determines whether or not a user act falls under a violative act, and

in a case where it is determined that a user act is a violative act, the management server notifies the user terminal or the monitoring device.

Moreover, the third aspect of the present disclosure is

an information processing method executed in an information processing device,

in which the information processing device includes a data processing unit configured to analyze a user act on the basis of sensor detection information,

the data processing unit determines whether or not a user act falls under a violative act, and

in a case where it is determined that a user act is a violative act, the data processing unit performs notification of a warning.

Moreover, the fourth aspect of the present disclosure is

an information processing method executed in an information processing system including a monitoring device, a management server, and a user terminal,

in which the monitoring device acquires detection information of a plurality of sensors provided in a monitoring region, and transmits the detection information to the management server,

the management server receives sensor detection information from the monitoring device, and determines whether or not a user act in the monitoring region falls under a violative act, on the basis of the received sensor detection information, and

in a case where it is determined that a user act is a violative act, the management server notifies the user terminal or the monitoring device.

Moreover, the fifth aspect of the present disclosure is

a program for causing an information processing device to execute information processing,

in which the information processing device includes a data processing unit configured to analyze a user act on the basis of sensor detection information, and

the program causes the data processing unit to execute

processing of determining whether or not a user act falls under a violative act, and

processing of performing notification of a warning in a case where it is determined that a user act is a violative act.

Note that the program of the present disclosure is a program that can be provided by a storage medium or a communication medium in a computer-readable format to an information processing device or a computer system that can execute various program codes, for example. By providing such a program in a computer-readable format, processing corresponding to the program is executed on the information processing device or the computer system.

Yet another object, features, and advantages of the present disclosure will become apparent by embodiments of the present disclosure to described later and more detailed description that is based on the attached drawings. Note that, in this specification, a system refers to a logical aggregate configuration of a plurality of devices, and devices of configurations are not always provided in the same casing.

### Effects of the Invention

According to a configuration of an embodiment of the present disclosure, a configuration of observing a user act in a monitoring region, performing detection of a violative act, and further generating credit information of each user is realized.

Specifically, for example, a monitoring device that acquires detection information of a sensor provided in a monitoring region, and transmits the detection information to a management server, the management server that analyzes a user act in the monitoring region on the basis of the sensor detection information, and a user terminal held by a user are included. The management server determines whether or not a user act falls under a violative act, and in a case where it is determined that a user act is a violative act, notifies the user terminal or the monitoring device. Moreover, the management server executes user identification, and generates and updates credit information of each user on the basis of an observation result of the user act of the identified user.

With this configuration, a configuration of observing a user act in a monitoring region, performing detection of a violative act, and further generating credit information of each user is realized.

Note that effects described in this specification are mere exemplifications and are not limited, and additional effects may be caused.

### BRIEF DESCRIPTION OF DRAWINGS

FIG. 1 is a diagram describing an overview of processing of the present disclosure.

FIG. 2 is a diagram describing a configuration of an information processing system of the present disclosure, and configuration examples of devices included in the system.

FIG. 3 is a diagram illustrating a flowchart describing a processing sequence of a first embodiment.

FIG. 4 is a diagram describing an example of a warning output to a user terminal.

FIG. 5 is a diagram describing an update processing example of credit information that is executed by a credit information generation update unit.

FIG. 6 is a diagram illustrating a flowchart describing a processing sequence of a second embodiment.

FIG. 7 is a diagram describing a specific example of processing executed by a warning notification output control unit and a credit information generation update unit of a management server.

FIG. 8 is a diagram illustrating a flowchart describing a processing sequence of a third embodiment.

FIG. 9 is a diagram describing an example of feedback response display data displayed on a user terminal.

FIG. 10 is a diagram describing an example of feedback response display data displayed on a user terminal.

FIG. 11 is a diagram illustrating a flowchart describing a processing sequence in a case where entry monitoring processing is performed for a user permitted to enter and a time-limited region.

FIG. 12 is a diagram illustrating a flowchart describing a processing sequence in a case where monitoring processing of user's check-out processing of goods (book) for which a check-out permissible time is set is performed.

FIG. 13 is a diagram illustrating a flowchart describing a processing sequence in a case where processing of further setting a user credit rating class that is based on a user act is performed in Processing Example 2.

FIG. 14 is a diagram describing the overall configuration of generation of user credit information in the system of the present disclosure, and usage processing thereof.

FIG. 15 is a diagram describing an example of a credit information item to be set on the basis of analysis of credit information that is executed by a management server.

FIG. 16 is a diagram describing an example of credit information calculated data for each user and for each credit information item that is generated by a management server.

FIG. 17 is a diagram describing a selection provision example of a credit information item corresponding to a credit information user.

FIG. 18 is a diagram describing a hardware configuration example of a monitoring device, management server, a monitoring requestor terminal, and a user terminal, which are devices included in the information processing system of the present disclosure.

### MODE FOR CARRYING OUT THE INVENTION

Hereinafter, details of an information processing device, an information processing system, and an information processing method, and a program of the present disclosure will be described with reference to the drawings. Note that the description will be given in accordance with the following items.

1. Overview of Processing of Present Disclosure

2. Configuration of Information Processing System, and Configuration Examples of Devices Included in System

3. (First Embodiment) Embodiment of Executing Warning Notification That Is Based on Detection of Violative Act of User, and Update of User Credit Rating

4. (Second Embodiment) Embodiment of Executing Notification and Update of User Credit Rating by Detecting Various User Acts Including Violative Act of User

5. (Third Embodiment) Embodiment of Permitting Feedback Response from User to Notification to User

6. Sequence of Specific Processing Example

6-1. (Processing Example 1) Processing Example of Performing Entry Monitoring Processing for User Permitted to Enter and Time-Limited Region

6-2. (Processing Example 2) Monitoring Processing Example of User's Check-Out Processing of Goods (Book) for Which Check-Out Permissible Time Is Set

6-3. (Processing Example 3) Processing Example of Further Setting User Credit Rating Class That Is Based on User Act in Processing Example 2

7. Usage of User Credit Information

8. Hardware Configuration Example of Information Processing Device

9. Conclusion of Configuration of Present Disclosure

### 1. Overview of Processing of Present Disclosure

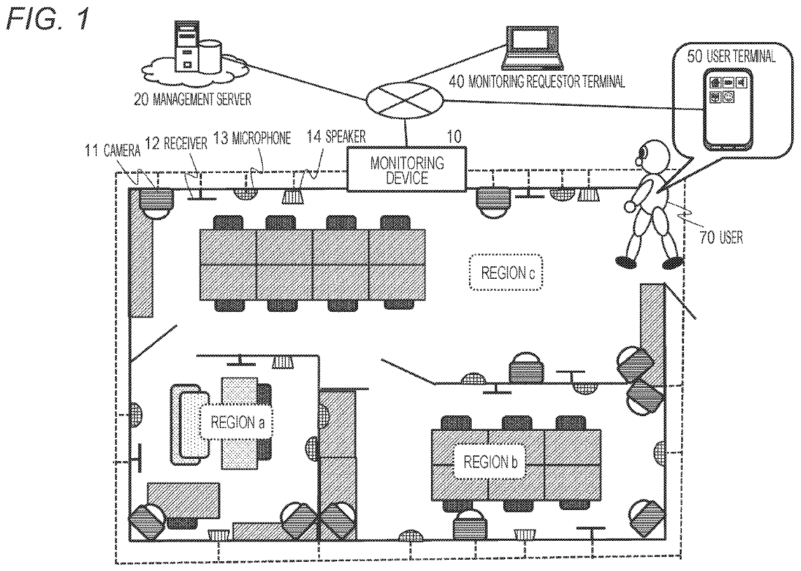

First of all, an overview of processing of the present disclosure will be described with reference to FIG. 1.

In a monitoring region in which a sensor such as a camera is provided, a system of the present disclosure performs monitoring of a human behavior in the monitoring region, such as human's entry to a specific location and human's check-out of goods.

As described above, examples of places available to many people include various places such as an accommodation facility, a working place, an airport, and an art museum. In these places, a region that only a specific permitted person can enter, goods forbidden to be checked out, and the like often exist.

FIG. 1 illustrates an example of a floor of an office as an example of a space in which a human behavior is to be monitored.

Note that FIG. 1 illustrates a floor of an office, but the processing of the present disclosure can be used in any location where a plurality of people goes in and out. For example, the processing of the present disclosure can be used in a location where a plurality of people goes in and out, such as a building, a station, an airport, an accommodation facility, an office, a working place, an apartment building, a hospital, an art museum, a private house for private residence rental, an amusement park, and a shopping mall.

FIG. 1 illustrates a monitoring device 10 that controls cameras 11, receivers 12, microphones 13, and speakers 14 that are attached to various locations of the floor of the office, and a management server 20, a monitoring requestor terminal 40, and a user terminal 50 that are connected via a network.

The user terminal 50 is a terminal owned by a user 70 who uses the floor of the office. Note that various devices such as a wireless communication devices such as a smartphone, an IC card, a radio frequency (RF) tag, for example, can be used as the user terminal 50.

The monitoring requestor terminal 40 is a terminal of a requestor who has requested the monitoring of a monitoring location, such as a company that owns the floor of the office.

The management server 20 receives an image acquired by the monitoring device 10 via the camera 11, the receiver 12, and the microphone 13, received information (for example, wireless communication signal such as RF signal, and the like), and voice information, analyzes a behavior of a human (user 70) by analyzing received information, and executes analysis processing for determining whether or not the user has performed an improper act, for example, and the like.

The improper act includes an act such as, for example, entry to an entry forbidden region, and check-out of check-out forbidden goods.

On the floor of the office illustrated in FIG. 1, various humans (users) such as many company members, visitants other than company members, and cleaning staffs wander back and forth.

An entry-permitted region and an entry-unpermitted region are allocated to each of these humans (users).

Furthermore, the setting of entry permission or non-permission is sometimes changed in accordance with a time slot.

The floor of the office illustrated in FIG. 1 includes three regions corresponding to a region a, a region b, and a region c. Among these regions, for example, the region a and the region b are regions of which entry permission is given only to a part of users. The region c is a region of which entry is unrestricted.

Users permitted to enter the region a and users permitted to enter the region b are different users.

Furthermore, for example, while cleaning staffs can enter all regions, an entry permitted time for the cleaning staffs is set to a cleaning time such as only a time from 6:00 to 7:00 in the morning, for example.

Furthermore, on the floor of the office illustrated in FIG. 1, a number of various goods such as personal computers, books, documents, and artistic handicraft products, for example, are placed. These goods include goods forbidden to be checked out, goods of which check-out permission is given only to a specific user, and the like.

Moreover, goods on which various check-out restrictions are put, such as goods that are not check-out forbidden goods, but have restrictions on a check-out time, such as goods permitted to be checked out for a time period equal to or smaller than two hours, for example, are placed.

The monitoring device 10 illustrated in FIG. 1 acquires sensor detection information for analyzing a user behavior for analyzing the presence or absence of these user acts, that is to say, user's entry to each region, user's check-out of goods, and the like, and transmits the sensor detection information to the management server 20. A sensor includes a camera, a microphone, a wireless receiver, and the like.

As illustrated in the drawing, the monitoring device 10 includes the camera 11, the receiver 12, the microphone 13, the speaker 14, and the like. The camera 11, the receiver 12, the microphone 13, and the speaker 14 are attached to each location of the floor, and monitor a behavior of a user moving within the floor, such as the user 70 illustrated in FIG. 1, for example.

The camera 11 captures an image of the inside of the floor. The captured image is transmitted from the monitoring device 10 to the management server 20.

The receiver 12 receives data (for example, a device ID or a user ID) transmitted by the user terminal 50 (smartphone, IC card, RF tag, and the like) owned by the user 70 moving within the floor. The received data is transmitted from the monitoring device 10 to the management server 20.

The microphone 13 acquires sound produced in the floor. The acquired voice data is transmitted from the monitoring device 10 to the management server 20.

Note that all of the camera 11, the receiver 12, and the microphone 13 are sensors for monitoring a user behavior, and in the configuration example illustrated in FIG. 1, an example in which three types of sensors corresponding to the camera 11, the receiver 12, and the microphone 13 are included is illustrated, but a configuration that uses only any one or two sensors of these may be employed. For example, a configuration that uses only the camera 11 may be employed. Furthermore, a configuration that uses a contact sensor, a proximity sensor, or the like, for example, that is other than a camera, a receiver, and a microphone may be employed.

Furthermore, a configuration that uses a stereo camera for making a user position or a three-dimensional position of goods measurable may be employed as the camera 11.

The speaker 14 is used for notifying the user 70 of a warning when an improper act performed by the user 70 is detected, for example.

Whether or not to output a warning is determined by the management server 20. On the basis of received information (image, received information, voice information) from the monitoring device 10, the management server 20 determines the occurrence or occurrence probability of an improper act performed by the user 70, such as entry to an entry forbidden region, and check-out of check-out forbidden goods, for example. In a case where the management server 20 determines that an improper act is likely to be performed by the user 70, the management server 20 determines a warning output, and outputs warning sound or a voice warning message via the speaker 14 of the monitoring device.

### 2. Configuration of Information Processing System, and Configuration Examples of Devices Included in System

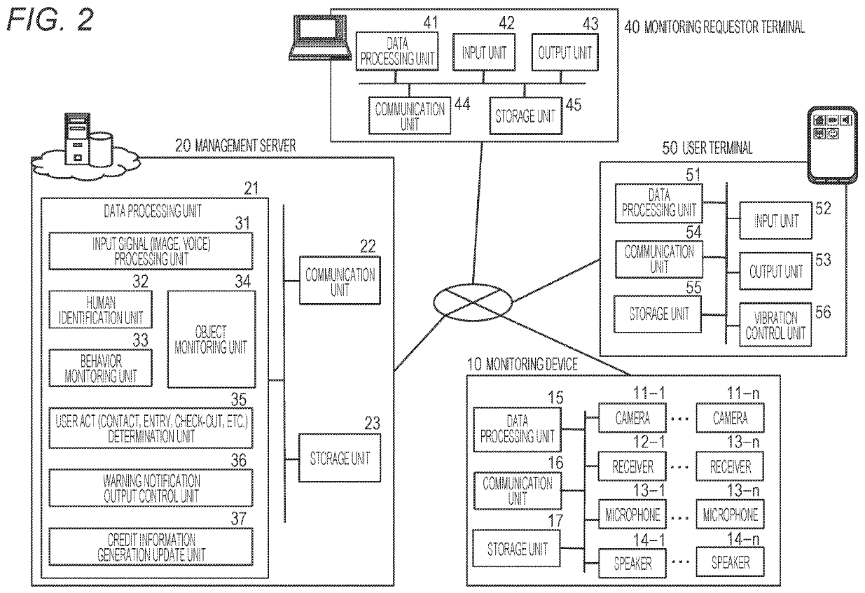

Next, a configuration of an information processing system of the present disclosure, and configuration examples of devices included in the system will be described with reference to FIG. 2.

FIG. 2 illustrates the respective configuration examples of the monitoring device 10, the management server 20, the monitoring requestor terminal 40, and the user terminal 50.

The respective configurations of the devices will be sequentially described.

(Monitoring Device 10)

The monitoring device 10 includes a plurality of cameras 11-1 to n, a plurality of receivers 12-1 to n, a plurality of microphones 13-1 to n, and a plurality of speakers 14-1 to n, and further includes a data processing unit 15, a communication unit 16, and a storage unit 17.

The plurality of cameras 11-1 to n, the plurality of receivers 12-1 to n, the plurality of microphones 13-1 to n, and the plurality of speakers 14-1 to n are attached to various positions in a monitoring region.

The plurality of cameras 11-1 to n, the plurality of receivers 12-1 to n, and the plurality of microphones 13-1 to n acquire images of the monitoring region, wireless communication information, and voice information.

As described above, the receiver 12 receives data (for example, a device ID or a user ID) transmitted by the user terminal 50 (smartphone, IC card, RF tag, and the like) owned by the user 70 moving within the floor.

The plurality of speakers 13-1 to n outputs warning sound or a warning message to the user.

Note that, in the monitoring device 10 illustrated in FIG. 2, three types of sensors corresponding to the camera 11, the receiver 12, and the microphone 13 are illustrated, but as described above, all of these sensors are sensors for monitoring a user behavior, and a configuration that uses only any one or two sensors of these may be employed. Furthermore, a configuration that uses a sensor other than a camera, a receiver, and a microphone may be employed.

The data processing unit 15 performs control of image capturing processing performed by the plurality of cameras 11-1 to n, wireless communication processing performed by the plurality of receivers 12-1 to n, and voice acquisition processing performed by the plurality of microphones 13-1 to n. Furthermore, the data processing unit 15 performs control of transmitting an acquired image of the camera, a received signal of the receiver, and acquired voice of the microphone to the management server 20, and the like. Moreover, the data processing unit 15 executes voice output control via the plurality of speakers 14-1 to n, and the like.

Note that, when transmitting an acquired image of the camera, acquisition data of the receiver, and acquired voice of the microphone to the management server 20, the data processing unit 15 executes compression coding processing and encryption processing on these pieces of transmitted data. This is for preventing leakage to the outside.

The communication unit 16 performs data transmission and reception with the management server 20 and other devices connected via a network.

The storage unit 17 records a captured image of the camera 11, a detection signal of the receiver 12, and acquired voice of the microphone 13. In the storage unit 17, various warning messages and the like are further recorded. Furthermore, a program on which a processing sequence to be executed in the data processing unit 15 is recorded, various parameters to be applied to data processing, and the like are also stored.

(Management Server 20)

A camera captured image, microphone acquired voice information, and the like are input to the management server 20 from the monitoring device 10, and the management server 20 analyzes a behavior of the user in a monitoring location. Specifically, the management server 20 analyzes the presence or absence of an improper act performed by the user such as, for example, entry to an entry forbidden region, check-out of check-out forbidden goods, and contact to contact-forbidden goods, and the like.

As illustrated in FIG. 2, the management server 20 includes a data processing unit 21, a communication unit 22, and a storage unit 23.

The data processing unit 21 includes an input signal (image, voice) processing unit 31, a human identification unit 32, a behavior monitoring unit 33, an object monitoring unit 34, a user act (contact, entry, check-out, etc.) detection unit 35, a warning notification output control unit 36, and a credit information generation update unit 37.

The input signal (image, voice) processing unit 31 of the data processing unit 21 inputs, via the communication unit 22, a camera captured image received from the monitoring device 10, received information of the receiver, and moreover, a signal of voice information acquired by the microphone, and the like, and executes processing of an input signal such as decoding processing, for example.

Compression coding and encryption processing have been performed on an image signal received from the monitoring device 10, received information of the receiver, and a voice signal, and the data processing unit 21 executes decoding processing of a received signal.

The human identification unit 32 performs identification of a human (user) on the basis of received data (image, received information, voice) from the monitoring device 10.

For example, the human identification unit 32 executes user identification by extracting a face region of a human (user) from a camera captured image, and executing matching processing with a face image of a registered user that is pre-registered in the storage unit 23.

Alternatively, the human identification unit 32 executes user identification by analyzing transmission data (for example, a device ID or a user ID) of a user terminal (smartphone, IC card, RF tag, and the like) that is included in received information, on the basis of the received information of the receiver, and executing matching processing with identification information (for example, a device ID or a user ID) of a registered user that is pre-registered in the storage unit 23.

Alternatively, the human identification unit 32 executes user identification by executing matching processing with a voice signal of a registered user that is pre-registered in the storage unit 23, on the basis of microphone acquired voice.

At least any of a face image of a registered user, an identifier (for example, a device ID or a user ID) compatible with a user terminal, and registration information of voice of the user is registered in the storage unit 23 in association with a user identifier.

The human identification unit 32 executes human identification (user identification) by executing matching processing between received data (image, received signal of the receiver, voice) from the monitoring device 10, and registered data of the storage unit 23.

Note that, in a case where received data (image, received signal of the receiver, voice) from the monitoring device 10 does not match data registered in the storage unit 23, registration processing of a new user may be performed at this time point. More specifically, processing of registering a new user identifier into the storage unit 23 together with received data (image, received signal of the receiver, voice) may be executed.

Alternatively, in a case where it is determined that a detected user is an unregistered user, it may be determined that a suspicious individual has entered, and processing of outputting a warning, and the like may be executed at the time.

The behavior monitoring unit 33 monitors a behavior of a user identified by the human identification unit 32.

The object monitoring unit 34 performs monitoring of various objects in the monitoring region such as goods on which check-out restrictions, contact restrictions, usage restrictions, or the like are set, such as, for example, art objects, personal computers, and books.

Note that correspondence data between monitoring target goods and restriction information (check-out restrictions, contact restrictions, usage restrictions) thereof is prestored in the storage unit 23.

The user act (contact, entry, check-out, etc.) detection unit 35 performs detection of a violative act performed by a user identified by the human identification unit 32. The violative act is, for example, entry to an entry forbidden region, contact to contact-forbidden goods, usage of usage-forbidden goods, check-out of check-out forbidden goods, and the like.

Entry forbidden region information and correspondence data between monitoring target goods and restriction information (check-out restrictions, contact restrictions, usage restrictions) thereof are prestored in the storage unit 23, and the user act (contact, entry, check-out, etc.) detection unit 35 determines the presence or absence of a violative act performed by the user, by executing matching processing between a user act detected by the behavior monitoring unit 33, an object detected by the object monitoring unit 34, and information stored in the storage unit 23.

In a case where a violative act performed by the user is detected by the user act (contact, entry, check-out, etc.) detection unit 35, the warning notification output control unit 36 determines a mode of notification to the user or a monitoring requestor, and executes output control of the determined notification.

Examples of output modes of notification to the user include:

(a) Output of warning sound or output of a warning message via the speaker 13 of the monitoring device 10,

(b) Output of warning sound, output of a warning message, or vibration output to the user terminal 50.

The warning notification output control unit 36 performs processing of determining at least any warning output mode of the above-described modes (a) and (b) in accordance with the mode of the user act (contact, entry, check-out and the like), and outputting a warning.

Moreover, the warning notification output control unit 36 executes processing of notifying the monitoring requestor terminal 40 that a violative act performed by the user has been detected.

The credit information generation update unit 37 performs processing of generating and updating credit information (credit rating) of each user in accordance with the presence or absence of a violative act of the user, and the like. The management server 20 not only outputs a warning in a case where the user performs a violative act, but also generates and updates credit information of each user on the basis of monitoring information of the user, and stores the credit information into the storage unit 23.

User credit information accumulated in the storage unit 23 is provided to various organizations, companies, and the like that use a user credit rating, such as an insurance company, a credit-card company, and a bank, for example.

Specific processing examples thereof will be described later.

The communication unit 22 executes communication with the monitoring device 10, the monitoring requestor terminal 40, and the user terminal 50, which are external devices communicating with the management server 20.

For example, the following data is stored in the storage unit 23.

(a) User information (face image data, identifier (for example, a device ID or a user ID) compatible with a user terminal, voice data of voice, and the like) of a registered user

(b) Entry permission information (entry permitted user information, entry permitted time information, and the like of each region) of a monitoring region

(c) Goods information of the monitoring region (correspondence data between monitoring target goods and restriction information (check-out restrictions, contact restrictions, usage restrictions) thereof)

(d) Credit information of a user

Note that a program on which a processing sequence to be executed in the data processing unit 21 is recorded, various parameters to be applied to data processing, and the like are also stored in the storage unit 23.

(Monitoring Requestor Terminal 40)

The monitoring requestor terminal 40 is a terminal of a requestor who has requested the monitoring of a monitoring target region or a monitoring location, such as a company that owns the floor of the office illustrated in FIG. 1, for example.

The monitoring requestor terminal 40 is formed by a terminal such as a PC, for example.

As illustrated in FIG. 2, the monitoring requestor terminal 40 includes a data processing unit 41, an input unit 42, an output unit 43, a communication unit 44, and a storage unit 45.

The data processing unit 41 executes generation and transmission of request content to the management server 20, analysis processing of monitoring result information received from the management server 20, and the like.

The input unit 42 is a user-operable input unit such as a keyboard or a mouse. The output unit 43 includes a display, a speaker, and the like. The communication unit 44 executes communication with an external device such as the management server 20.

The storage unit 45 stores a data processing program to be executed by the data processing unit 41, parameters to be applied to data processing, and the like.

(User Terminal 50)

The user terminal 50 is a terminal owned by a user who uses a monitoring target region such as, for example, the floor of the office illustrated in FIG. 1. For example, the user terminal 50 includes a device including a data communication function, such as a smartphone, an IC card, or an RF tag. The IC card and the RF tag output an identifier (for example, a device ID or a user ID) compatible with the user terminal.

As illustrated in FIG. 2, the user terminal 50 includes a data processing unit 51, an input unit 52, an output unit 53, a communication unit 54, a storage unit 55, and a vibration control unit 56.

The data processing unit 51 executes warning sound output, message output, output control of warning vibration, and the like in accordance with a warning transmitted from the management server 20, for example.

The input unit 52 is a user-operable input unit such as a touch panel. The output unit 53 includes a display, a speaker, a vibrator, and the like.

The communication unit 54 is communication unit that executes communication with an external device such as the management server 20. Furthermore, the communication unit 54 also includes a communication unit that outputs an identifier (for example, a device ID or a user ID) compatible with the user terminal, to the receiver 12, which is a component of the monitoring device 10.

The storage unit 55 stores a data processing program to be executed by the data processing unit 51, parameters to be applied to data processing, and the like.

The vibration control unit 56 is a vibration function, and is a function of vibrating the user terminal 50 as warning output.

Note that, as described above, the user terminal 50 can be formed by various devices such as a smartphone, an IC card, and a tag for wireless communication, for example, and the user terminal 50 has a different configuration in accordance with the device. The configuration including the data processing unit 51 to the vibration control unit 56 that is illustrated in FIG. 2 is an example of the user terminal 50, and the user terminal needs not have a configuration including all of the data processing unit 51 to the vibration control unit 56.

### 3. First Embodiment

### Embodiment of Executing Warning Notification that is Based on Detection of Violative Act of User, and Update of User Credit Rating

Next, an embodiment of executing warning notification that is based on detection of a violative act of a user, and update of a user credit rating will be described as the first embodiment.

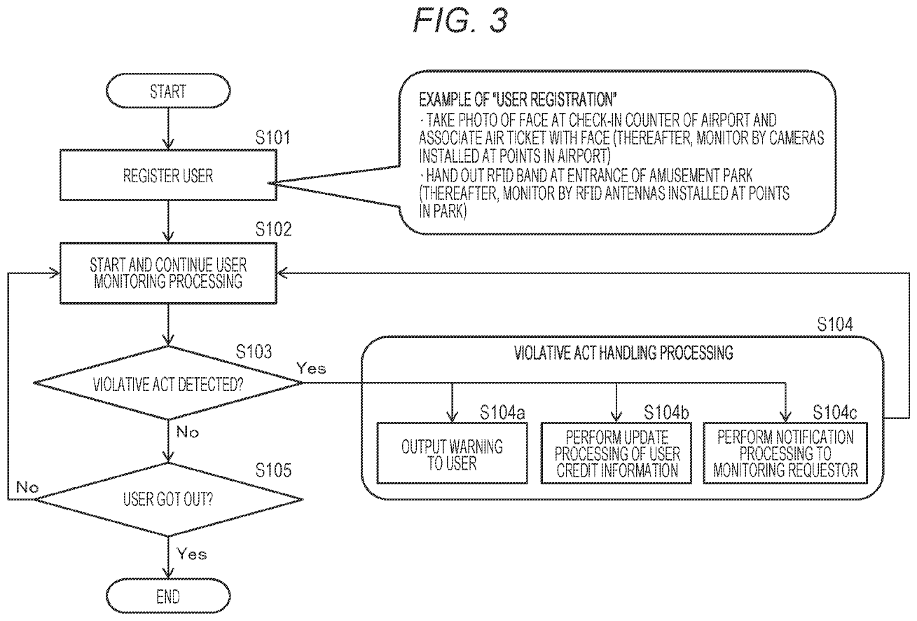

FIG. 3 is a flowchart describing a processing sequence of the first embodiment.

Hereinafter, processing in each step of the flow will be sequentially described.

(Step S101)

First of all, in Step S101, user registration processing is executed.

The user registration processing is registration processing of a user who enters a monitoring region.

The monitoring region is, for example, the floor of the office illustrated in FIG. 1, a building, an airport, an art museum, an amusement park, or the like, and is a restricted region in which a behavior of the user can be monitored by the camera, the receiver, and the microphone of the monitoring device 10.

The user executes user registration processing preliminarily or when entering a monitoring region. An example of the user registration processing is registration processing of a face of the user, for example. A face image is captured by a camera and stored into the storage unit 23 of the management server 20 as registered user information.

Alternatively, a user terminal that can transmit ID information, such as, for example, a tag having a communication function such as, for example, an RF tag or an IC card may be delivered to a user and the user may be prompted to wear the user terminal. In this case, ID information of the user terminal (RF tag, IC card, or the like) delivered to the user is stored into the storage unit 23 of the management server 20 as registered user information.

Alternatively, registration processing of voice of the user may be executed. The voice input from the microphone is stored into the storage unit 23 of the management server 20 as registered user information.

(Step S102)

If the user of which user registration processing has been completed in Step S101 enters the monitoring region, in Step S102, monitoring processing of the user is started.

The processing is monitoring processing that uses sensors of the monitoring device 10 such as, for example, the camera 11, the receiver 12, and the microphone 13.

As described above with reference to FIG. 1, a number of cameras 11, receivers 12, and microphones 13 are attached within the monitoring region, and acquired information (image, wireless communication information, voice information) of the cameras 11, the receivers 12, the microphones 13 is transmitted from the monitoring device 10 to the management server 20 as needed. The management server 20 analyzes received information (image, wireless communication information, voice information) from the monitoring device 10.

Specifically, the monitoring processing in Step S102 is executed by the behavior monitoring unit 33 and the object monitoring unit 34 of the management server 20, which have been described above with reference to FIG. 2.

As described above, the behavior monitoring unit 33 monitors a behavior of a user identified by the human identification unit 32. The object monitoring unit 34 performs monitoring of various objects in the monitoring region such as goods on which check-out restrictions, contact restrictions, usage restrictions, or the like are set, such as, for example, art objects, personal computers, and books.

(Step S103)

Next, in Step S103, it is determined whether or not a violative act performed by the user has been detected.

The violative act presence or absence determination processing in Step S103 is executed by the user act (contact, entry, check-out, etc.) detection unit 35 of the management server 20, which has been described with reference to FIG. 2.

As described above, the user act (contact, entry, check-out, etc.) detection unit 35 performs detection of a violative act performed by a user identified by the human identification unit 32. For example, the user act (contact, entry, check-out, etc.) detection unit 35 detects the presence or absence of entry to an entry forbidden region, contact to contact-forbidden goods, usage of usage-forbidden goods, check-out of check-out forbidden goods, and the like.

As described above, entry forbidden region information and correspondence data between monitoring target goods and restriction information (check-out restrictions, contact restrictions, usage restrictions) thereof are stored in the storage unit 23 of the management server 20, and the user act (contact, entry, check-out, etc.) detection unit 35 determines the presence or absence of a violative act performed by the user, by executing matching processing between a user act detected by the behavior monitoring unit 33, an object detected by the object monitoring unit 34, and information stored in the storage unit 23.

In a case where a violative act performed by the user has been detected in Step S103, the processing proceeds to Step S104.

On the other hand, in a case where a violative act performed by the user has not been detected, the processing proceeds to Step S105.

(Step S104)

In a case where a violative act performed by the user has been detected in Step S103, the processing proceeds to Step S104.

In Step S104, as illustrated in the flow, the following three pieces of processing are executed.

(S104a) Warning output to the user

(S104b) Update processing of user credit information

(S104c) Notification processing to a monitoring requestor

(S104a) The warning output to the user is warning output for requesting the user to stop a violative act.

The processing is processing executed by the warning notification output control unit 36 of the management server 20 illustrated in FIG. 2.

As described above, in a case where a violative act performed by the user is detected by the user act (contact, entry, check-out, etc.) detection unit 35, the warning notification output control unit 36 determines the type of a warning to be output, and executes output control of the determined warning.

For example, as an output mode of a warning, at least any of the following warning outputs is executed:

(a) output of warning sound or output of a warning message via the speaker 13 of the monitoring device 10,

(b) output of warning sound, output of a warning message, or vibration output to the user terminal 50.

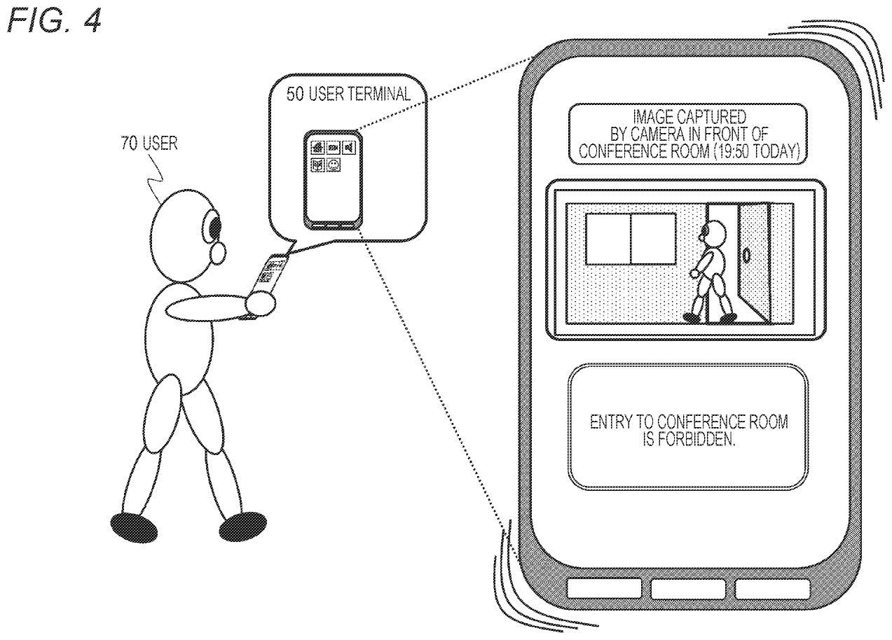

FIG. 4 illustrates an example of a warning output. The example illustrated in FIG. 4 is an example in which a warning message is output to the user terminal 50.

The example illustrated in FIG. 4 is an output example of a warning message in a case where the user 70 has tried to enter a conference room being an entry forbidden region.

Together with a camera captured image illustrating that the user is trying to enter a conference room being an entry forbidden region, and image captured time information, a warning message indicating that “entry to conference room is forbidden.” is displayed on a display unit of the user terminal 50.

Note that processing of vibrating the user terminal 50 is also executed in synchronization with a display timing of the warning message.

(S104b) The update processing of user credit information is processing executed by the credit information generation update unit 37 of the management server 20 illustrated in FIG. 2.

The credit information generation update unit 37 performs processing of generating and updating credit information (credit rating) of each user in accordance with the presence or absence of a violative act of the user, and the like.

The credit information generation update unit 37 generates and updates credit information (credit rating) of each user on the basis of monitoring information of the user, and stores the credit information into the storage unit 23.

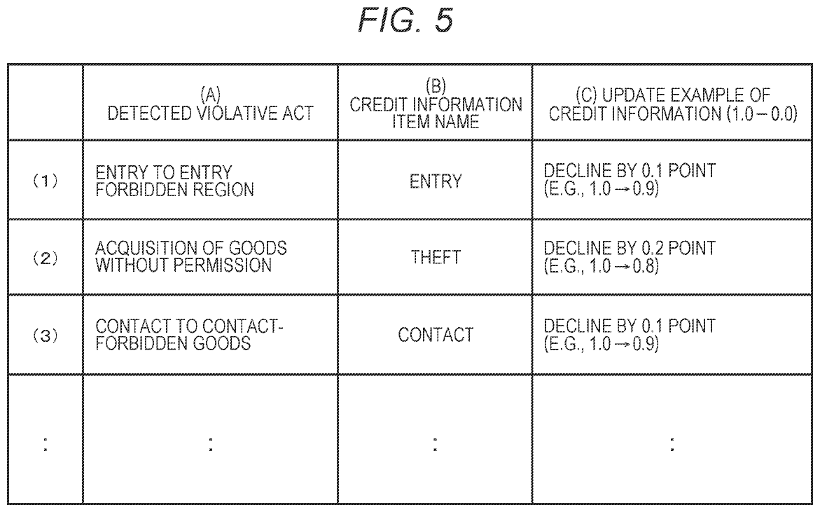

FIG. 5 illustrates an update processing example of credit information in the credit information generation update unit 37. Note that credit information is generated for each user.

FIG. 5 illustrates a correspondence table of the following data.

(A) Detected violative act

(B) Credit information item name

(C) Update example of credit information (1.0-0.0)

In “(A) Detected violative act”, an example of a violative act of the user that is to be detected by a camera or the like of the monitoring device 10 is illustrated.

“(B) Credit information item name” illustrates a credit information item name set in association with a detection violative act. The credit information item is an item category of credit information of the user, and an item name corresponding to the type of a violative act such as entry, theft, or contact is preliminarily defined.

In “(C) Update example of credit information (1.0-0.0)”, an update example of credit information that is executed by the credit information generation update unit 37 in accordance with“(A) detected violative act” is illustrated.

Note that, in this example, as for credit information, 1.0 is the highest credit rating, and 0.0 is the lowest credit rating

For example, an example of an entry (1) is an example in a case where “(A) detected violative act” is “entry to an entry forbidden region”.

In this case, the credit information generation update unit 37 executes credit information update processing of lowering credit information (1.0-0.0) corresponding to “(B) credit information item name”=“entry” by 0.1 point.

An example of an entry (2) is an example in a case where “(A) detected violative act” is “acquisition of goods without permission”.

In this case, the credit information generation update unit 37 executes credit information update processing of lowering credit information (1.0-0.0) corresponding to “(B) credit information item name”=“theft” by 0.2 point.

An example of an entry (3) is an example in a case where “(A) detected violative act” is “contact to contact-forbidden goods”.

In this case, the credit information generation update unit 37 executes credit information update processing of lowering credit information (1.0-0.0) corresponding to “(B) credit information item name”=“contact” by 0.1 point.

In this manner, the credit information generation update unit 37 performs update processing of changing credit information (1.0-0.0) of a credit information item corresponding to a detected violative act, in accordance with the detected violative act, and stores the update data into the storage unit 23.

Note that, while various settings can be set as a default value of a credit rating, as an example, processing is started with a credit rating default value=1.0 (highest credit rating), for example.

(S104c) The notification processing to a monitoring requestor is processing executed by the warning notification output control unit 36 of the management server 20 illustrated in FIG. 2.

In a case where a violative act performed by the user is detected by the user act (contact, entry, check-out, etc.) detection unit 35, the warning notification output control unit 36 executes processing of notifying not only the user but also a monitoring requestor that a violative act performed by the user has been detected.

In this manner, in a case where a violative act performed by the user has been detected in Step S103, in Step S104, these three types of processing, that is to say, the following processing is executed.

(S104a) Warning output to the user

(S104b) Update processing of user credit information

(S104c) Notification processing to a monitoring requestor

After these pieces of processing, the processing returns to Step S102, and monitoring of the user is continued.

(Step S105)

Step S105 is processing of determining whether or not the user has got out of the monitoring region.

In a case where the user has got out of the monitoring region, the processing ends. In a case where the user has not got out of the monitoring region, the processing returns to Step S102, and monitoring of the user is continued.

### 4. Second Embodiment

### Embodiment of Executing Notification and Update of User Credit Rating by Detecting Various User Acts Including Violative Act of User

The processing described with reference to the flowchart illustrated in FIG. 3 has a configuration of issuing a notification to the user and a monitoring requestor in a case where a violative act performed by the user has been detected, and further executing generation and update of a user credit rating.

Next, an embodiment of analyzing various user acts including not only violative acts of the user but also good acts other than violative acts, and the like, issuing a notification to the user or a monitoring requestor on the basis of an analysis result, and further executing generation and update of a user credit rating will be described.

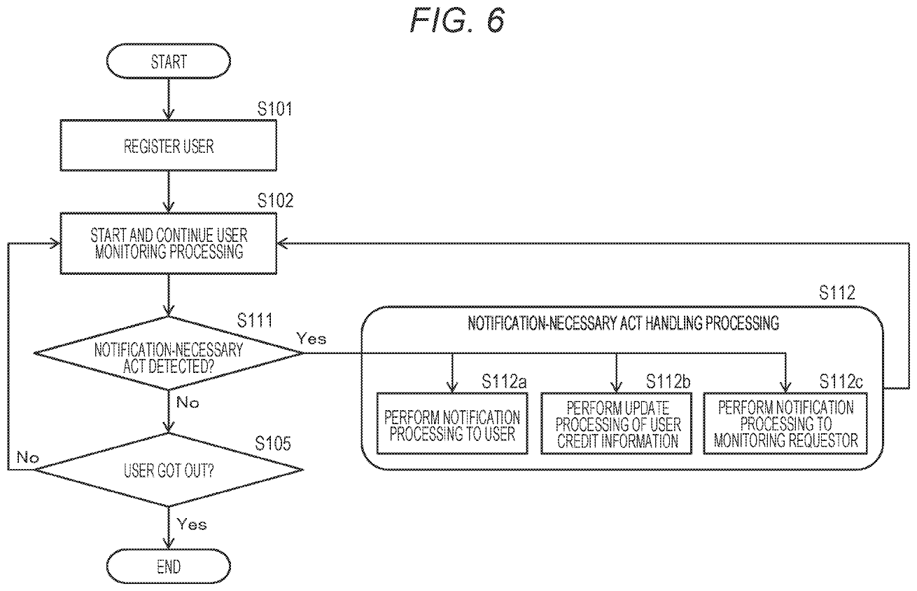

The flow illustrated in FIG. 6 is a flowchart describing a processing sequence according to the present embodiment.

The flow illustrated in FIG. 6 is a flow in which the processing in Steps S103 and S104 in the flow illustrated in FIG. 3, which has been described above, is replaced with processing in Steps S111 and S112.

The processing in Steps S101 to S102 and the processing in Step S105 become processing similar to the processing in the flow illustrated in FIG. 3, which has been described above.

Hereinafter, processing in each step of the flow will be sequentially described.

(Steps S101 to S102)

Because the processing in Steps S101 to S102 is processing similar to the processing in the flow illustrated in FIG. 3, which has been described above, the processing will be briefly described.

First of all, in Step S101, user registration processing is executed.

Next, in Step S102, monitoring processing of the user is started.

(Step S111)

Next, in Step S111, it is determined whether or not a user act requiring notification to the user or a monitoring requestor (notification-necessary act) has been detected.

The processing in Step S111 is executed by the user act (contact, entry, check-out, etc.) detection unit 35 of the management server 20 described with reference to FIG. 2.

A user act requiring notification to the user or a monitoring requestor is stored in the storage unit 23 of the management server 20 illustrated in FIG. 2.

In a case where a notification-necessary act has been detected in Step S111, the processing proceeds to Step S112.

On the other hand, in a case where a violative act performed by the user has not been detected, the processing proceeds to Step S105.

(Step S112)

In a case where a notification-necessary act has been detected in Step S111, the processing proceeds to Step S112.

In Step S112, as illustrated in the flow, the following three pieces of processing are executed.

(S112a) Notification processing to the user

(S112b) Update processing of user credit information

(S112c) Notification processing to a monitoring requestor

These pieces of processing are executed by the warning notification output control unit 36 and the credit information generation update unit 37 of the management server 20.

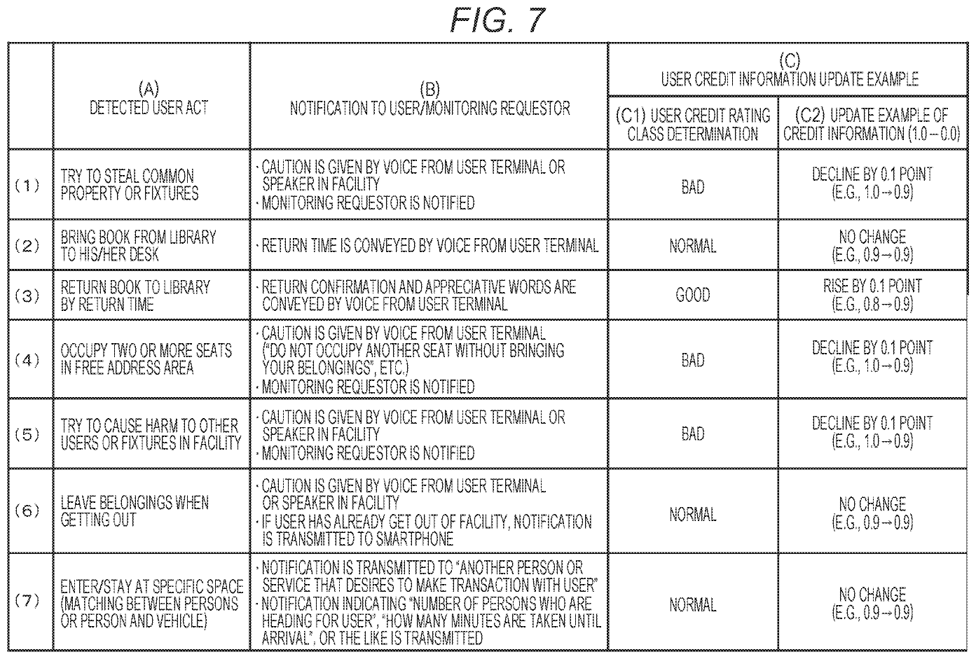

A specific example of the processing executed by the warning notification output control unit 36 and the credit information generation update unit 37 of the management server 20 will be described with reference to FIG. 7.

FIG. 7 illustrates a correspondence table of the following data.

(A) Detected user act

(B) Notification to user/monitoring requestor

(C) User credit information update example

(C1) User credit rating class determination

(C2) User credit information (1.0-0.0) update example

In “(A) Detected user act”, an example of an act of the user that is to be detected by a camera or the like of the monitoring device 10 is illustrated.

The “(A) detected user act” is an act defined to perform notification to the user or a monitoring requestor. These acts are pre-registered in the storage unit 23 of the management server 20 as “notification-necessary acts”.

“(B) Notification to user/monitoring requestor” illustrates examples of notification executed to the user or a monitoring requestor by the warning notification output control unit 36 of the management server 20 in accordance with the detected user act. Specifically, this illustrates examples of notification executed to the user terminal 50 or the monitoring requestor terminal 40.

In a case where a user act is a “notification-necessary act” registered in the storage unit 23, the warning notification output control unit 36 executes notification illustrated in (B), in accordance with each user act.

“(C) User credit information update example” illustrates an update example of credit information that is executed by the credit information generation update unit 37 of the management server 20 in accordance with the detected user act.

“(C) User credit information update example” illustrates (C1) user credit rating class determination and (C2) user credit information (1.0-0.0) update example.

The “(C1) user credit rating class determination” is a class determination result of a detected user act.

The credit information generation update unit 37 of the management server 20 classifies classes of detected user acts into three classes corresponding to “good”, “normal”, and “bad”.

In a case where a user act classified into the “good” class has been detected, the credit information generation update unit 37 executes credit information update processing of rising “(C2) user credit information (1.0-0.0)”.

In a case where a user act classified into the “bad” class has been detected, the credit information generation update unit 37 executes credit information update processing of lowering “(C2) user credit information (1.0-0.0)”.

In a case where a user act classified into the “normal” class has been detected, “(C2) user credit information (1.0-0.0)” is not changed.

In this manner, the management server 20 performs notification processing of various user acts to the user terminal 50 or the monitoring requestor terminal 40, and classifies user acts into three classes corresponding to classes of “good”, “normal”, and “bad”, and performs credit information update processing by executing up-down processing of credit information in accordance with a class.

After the processing in Step S112, the processing returns to Step S102, and monitoring processing of the user is continued.

(Step S105)

Step S105 is processing of determining whether or not the user has got out of the monitoring region.

In a case where the user has got out of the monitoring region, the processing ends. In a case where the user has not got out of the monitoring region, the processing returns to Step S102, and monitoring of the user is continued.

### 5. Third Embodiment

### Embodiment of Permitting Feedback Response from User to Notification to User

Next, an embodiment of permitting a feedback response from a user to a notification to the user will be described as the third embodiment.

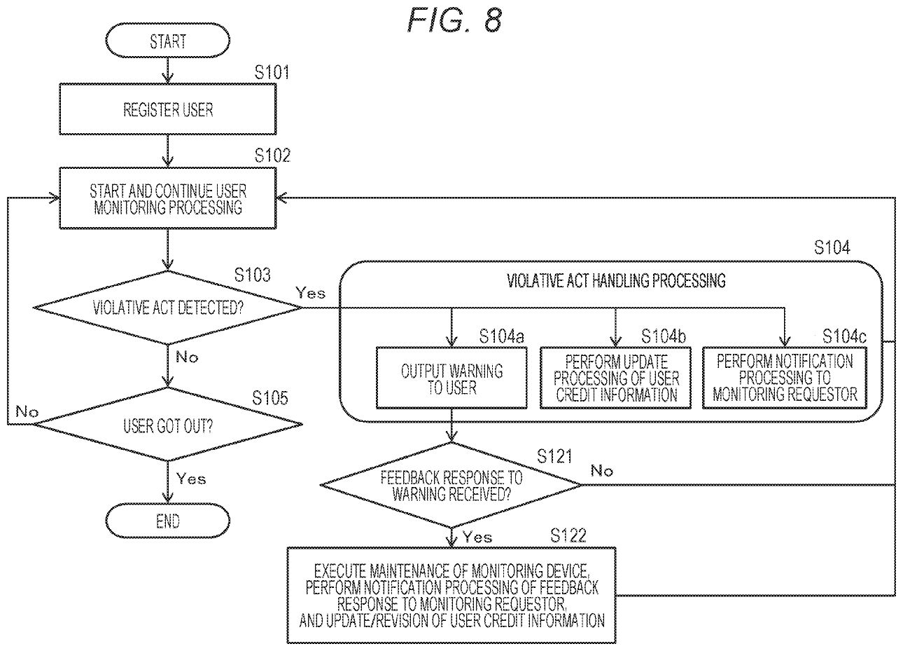

The flow illustrated in FIG. 8 is a flowchart describing a processing sequence according to the present embodiment.

The processing in Steps S101 to S105 of the flow illustrated in FIG. 8 becomes processing similar to the processing in the flow illustrated in FIG. 3, which has been described above.

In the sequence of the present embodiment, Steps S121 to S122 are added after warning notification to the user in Step S104a.

Hereinafter, the processing in Steps S121 to S122 will be mainly described.

(Steps S101 to S103)

Because the processing in Steps S101 to S103 is processing similar to the processing in the flow illustrated in FIG. 3, which has been described above, the processing will be briefly described.

First of all, in Step S101, user registration processing is executed.

Next, in Step S102, monitoring processing of the user is started.

Next, in Step S103, it is determined whether or not a violative act performed by the user has been detected.

In a case where a violative act performed by the user has been detected in Step S103, the processing proceeds to Step S104.

On the other hand, in a case where a violative act performed by the user has not been detected, the processing proceeds to Step S105.

(Step S104)

In a case where a violative act performed by the user has been detected in Step S103, the processing proceeds to Step S104.

In Step S104, as illustrated in the flow, the following three pieces of processing are executed.

(S104a) Warning output to the user

(S104b) Update processing of user credit information

(S104c) Notification processing to a monitoring requestor

These pieces of processing are processing similar to the processing described with reference to FIG. 3.

(Step S121)

In the present embodiment, after warning output to the user in Step S104a, the processing in Steps S121 to S122 is executed.

First of all, in Step S121, the management server 20 determines the presence or absence of a feedback response from the user.

In a case where a feedback response from the user has been received, the processing proceeds to Step S122.

In a case where a feedback response from the user has not been received, the processing returns to Step S102, and monitoring processing is continued.

A feedback response from the user is executed using the user terminal 50 owned by the user 70, and is transmitted from the user terminal 50 to the management server 20.

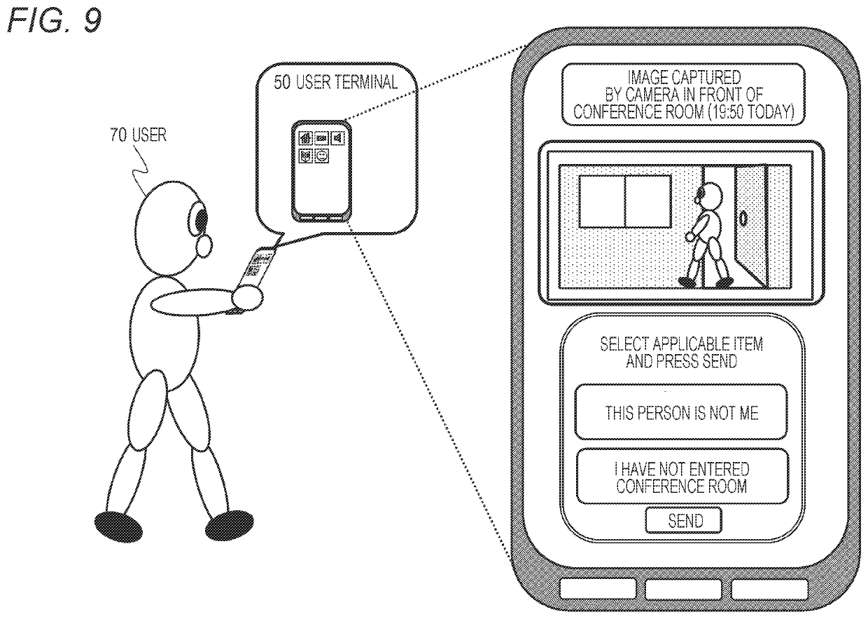

FIG. 9 illustrates an example of feedback response display data displayed on the user terminal 50.

The example illustrated in FIG. 9 is an example of feedback response display data displayed after the user who has tried to enter a conference room being an entry forbidden region is detected and a warning message is output.

Together with a camera captured image illustrating that the user is trying to enter a conference room being an entry forbidden region, and image captured time information, a screen that enables the following two feedback responses is displayed on a display unit of the user terminal 50 as a feedback response screen region.

“This person is not me”

“I have not entered conference room”

The user can select any of these and perform send processing.

Sent data is transmitted from the user terminal 50 to the management server 20.

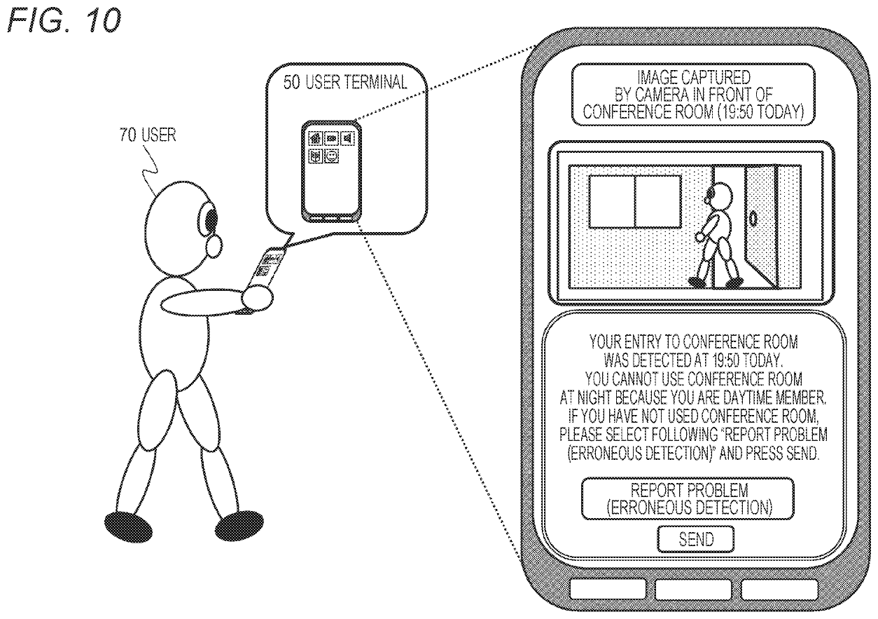

FIG. 10 illustrates another example of feedback response display data.

Similarly to the example illustrated in FIG. 9, the example illustrated in FIG. 10 is also an example of feedback response display data displayed after the user who has tried to enter a conference room being an entry forbidden region is detected and a warning message is output.

Together with a camera captured image illustrating that the user is trying to enter a conference room being an entry forbidden region, and image captured time information, the following explanatory text is displayed on a display unit of the user terminal 50 in a feedback response screen region.

“Your entry to conference room was detected at 19:50 today. You cannot use conference room at night because you are daytime member. If you have not used conference room, please select following “report problem (erroneous detection)” and press send.”

The user can select “report problem (erroneous detection)” and perform send processing.

Sent data is transmitted from the user terminal 50 to the management server 20.

In this manner, the management server 20 generates feedback response display data in various forms, and displays the feedback response display data on the user terminal 50.

Using feedback response display data provided by the management server 20, the user can perform a feedback response to the management server 20.

(Step S122)

In Step S122, the management server 20 that has received a feedback response from the user in Step S121 executes maintenance of the monitoring device, notification processing of a feedback response to a monitoring requestor, update/revision processing of user credit information, and the like.

The maintenance of the monitoring device is processing of analyzing the cause of erroneous detection, changing the setting of a sensor that has caused erroneous detection, and the like.

The notification processing of a feedback response to a monitoring requestor is processing of notifying that wrong warning notification has been executed to the user.

The update/revision processing of user credit information is processing of returning credit information updated in accordance with an erroneously detected user violative act, to an original state, such as processing of returning user credit information updated in Step S104b, to an original state.

After the processing in Step S122, the processing returns to Step S102, and monitoring processing of the user is continued.

(Step S105)

Step S105 is processing of determining whether or not the user has got out of the monitoring region.

In a case where the user has got out of the monitoring region, the processing ends. In a case where the user has not got out of the monitoring region, the processing returns to Step S102, and monitoring of the user is continued.

### 6. Sequence of Specific Processing Example

Next, a plurality of processing sequences of a specific processing example of processing of the present disclosure will be described.

Each of the following processing examples will be described.

(Processing Example 1) Processing Example of Performing Entry Monitoring Processing for User Permitted to Enter and Time-Limited Region

(Processing Example 2) Monitoring Processing Example of User's Check-Out Processing of Goods (Book) for Which Check-Out Permissible Time Is Set

(Processing Example 3) Processing Example of Further Setting User Credit Rating Class That Is Based on User Act in Processing Example 2

### 6-1. Processing Example 1

### Processing Example of Performing Entry Monitoring Processing for User Permitted to Enter and Time-Limited Region

First of all, a processing example of performing entry monitoring processing for a user permitted to enter and a time-limited region will be described as a specific processing example 1.

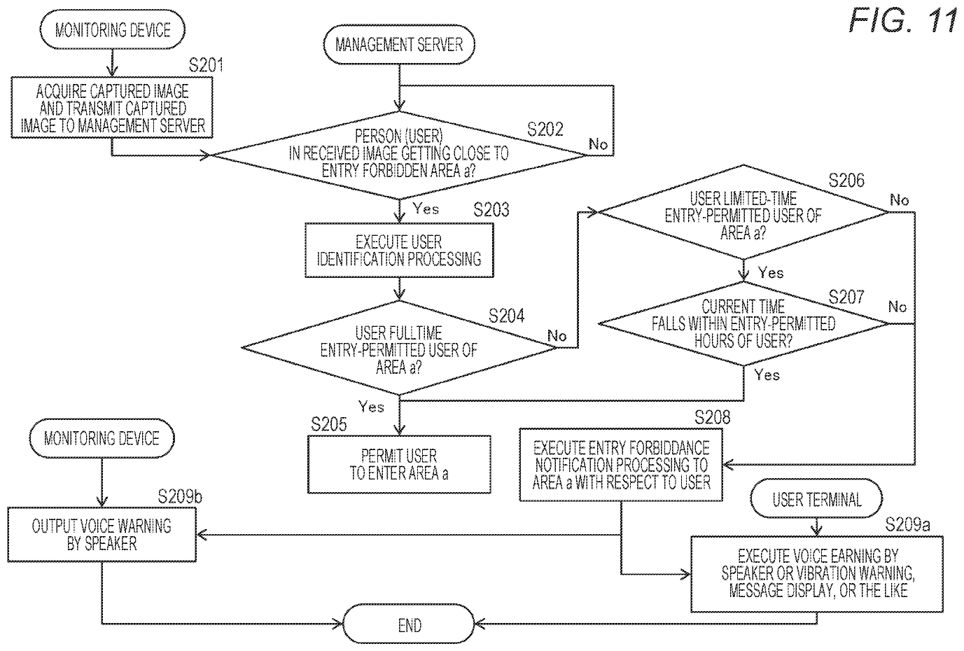

The flowchart illustrated in FIG. 11 is a flowchart describing a processing sequence of the processing example 1.

Note that, in the flow illustrated in FIG. 11, processing executed by the monitoring device 10, processing executed by the management server 20, and processing executed by the user terminal 50 are separately illustrated.

The processing is executed in the order of Steps S201 to S209.

Hereinafter, processing in each step will be sequentially described.

(Step S201)

First of all, in Step S201, the monitoring device 10 acquires a captured image obtained by a camera, and transmits the captured image to the management server 20.

(Step S202)

Next, in Step S202, the management server 20 analyzes the camera captured image received from the monitoring device 10, and determines whether or not the user is getting close to an entry forbidden area a.

In a case where it is confirmed that the user is getting close, the processing proceeds to Step S203. In a case where it is not confirmed that the user is getting close, the processing in Step S202, that is to say, analysis of a camera captured image sequentially input from the monitoring device 10 is continuously executed.

(Step S203)

In a case where the management server 20 determines that a certain user is getting close to the entry forbidden area a, by the analysis of a camera captured image received from the monitoring device 10, in Step S203, user identification processing of the user is executed.

For example, user identification is performed by executing matching processing between a face image included in the camera captured image, and a face image of a registered user that is prestored in the storage unit 23 of the management server 20.

(Step S204)

Next, in Step S204, the management server 20 determines whether or not an identified user is a “fulltime entry-permitted user” permitted to enter the area a any time.

Note that entry permission information of the user for each area has already been recorded in the storage unit 23 of the management server 20 as user management information.

Referring to the user management information stored in the storage unit 23, the management server 20 determines whether or not an identified user is a “fulltime entry-permitted user”.

In a case where it is confirmed that the identified user is a “fulltime entry-permitted user”, the processing proceeds to Step S205.

On the other hand, in a case where it is confirmed that the identified user is not a “fulltime entry-permitted user”, the processing proceeds to Step S206.

(Step S205)

In a case where it is confirmed in the determination processing in Step S204 that the identified user is a “fulltime entry-permitted, the processing proceeds to Step S205.

In Step S205, the management server 20 permits the user to enter the area a, without outputting a warning.

(Step S206)

On the other hand, in a case where it is confirmed in the determination processing in Step S204 that the identified user is not a “fulltime entry-permitted, the processing proceeds to Step S206.

In Step S206, the management server 20 determines whether or not the identified user is a “limited-time entry-permitted user” permitted to enter the area a only within a specific time slot.

Note that the information is also recorded in the storage unit 23, and the management server 20 determines whether or not the identified user is a “limited-time entry-permitted user”, referring to the information stored in the storage unit 23.

In a case where it is confirmed that the identified user is a “limited-time entry-permitted user”, the processing proceeds to Step S207.

On the other hand, in a case where it is confirmed that the identified user is not a “limited-time entry-permitted user”, the processing proceeds to Step S208.

(Step S207)

In a case where it is confirmed in the determination processing in Step S206 that the identified user is a “limited-time entry-permitted user”, the processing proceeds to Step S207.

In Step S207, the management server 20 determines whether or not the current time falls within entry-permitted hours into the area a for the identified user.

In a case where it is confirmed that the current time falls within entry-permitted hours, the processing proceeds to Step S205.

On the other hand, in a case where it is confirmed that the current time falls outside entry-permitted hours, the processing proceeds to Step S208.

In a case where it is confirmed in Step S207 that the current time falls within entry-permitted hours, the processing proceeds to Step S205, and the management server 20 permits the user to enter the area a, without outputting a warning.

(Step S208)

In a case where it is confirmed in Step S206 that the identified user is not a “limited-time entry-permitted user”, or in a case where it is confirmed in Step S207 that the current time falls outside entry-permitted hours, the processing proceeds to Step S208.

In these case, in Step S208, the management server 20 executes warning output for notifying the user that entry to the area a is forbidden.

(Step S209a, b)

Step S209a, b is processing executed as a result of warning output executed by the management server 20 in Step S208.

Step S209a is warning output processing in the user terminal 50. Warning such as output of voice warning via the speaker of the user terminal 50, vibration warning, or displaying of a message on a screen is performed.

Furthermore, Step S209b is output of voice warning via the speaker being equipment of the monitoring device 10.

Note that it is only required that at least any of these outputs is executed.

The user who has confirmed any of these warnings recognizes that entry to the area a is forbidden, and stops entry.

### 6-2. Processing Example 2

### Monitoring Processing Example of User's Check-Out Processing of Goods (Book) for which Check-Out Permissible Time is Set

Next, a monitoring processing example of user's check-out processing of goods (book) for which a check-out permissible time is set will be described as a specific processing example 2.

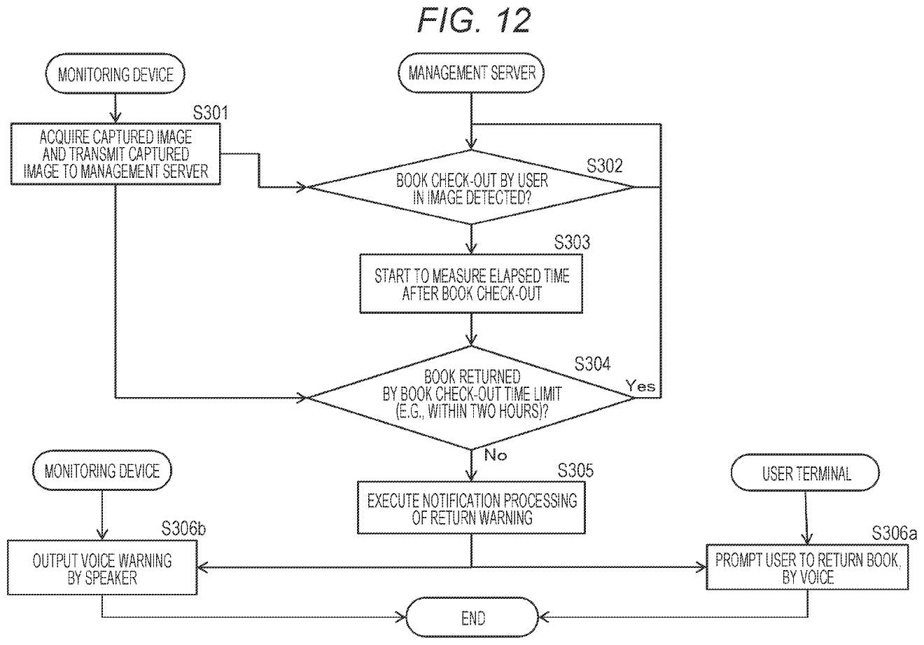

The flowchart illustrated in FIG. 12 is a flowchart describing a processing sequence of the processing example 2.

Note that, similarly to the flow illustrated in FIG. 11, in the flow illustrated in FIG. 12, processing executed by the monitoring device 10, processing executed by the management server 20, and processing executed by the user terminal 50 are separately illustrated as well.

The processing is executed in the order of Steps S301 to S306.

Hereinafter, processing in each step will be sequentially described.

(Step S301)

First of all, in Step S301, the monitoring device 10 acquires a captured image obtained by a camera, and transmits the captured image to the management server 20.

(Step S302)

Next, in Step S302, the management server 20 analyzes the camera captured image received from the monitoring device 10, and determines whether or not book check-out performed by the user has been detected.

Note that this book is assumed to be a book for which a check-out time limit is set (for example, two hours). Usage restriction information of book and other goods is registered in the storage unit 23 of the management server 20.

In a case where book check-out performed by the user has been detected, the processing proceeds to Step S303. In a case where book check-out performed by the user has not been detected, the processing in Step S302, that is to say, analysis of a camera captured image sequentially input from the monitoring device 10 is continuously executed.

(Step S303)

In a case where book check-out performed by the user is confirmed on the basis of a camera captured image received from the monitoring device 10, in Step S303, the management server 20 starts to measure an elapsed time after the book check-out performed by the user.

(Step S304)

Next, in Step S304, the management server 20 determines whether or not the user has returned the book within the predetermined check-out time limit (for example, two hours). The determination processing is executed on the basis of an image received from the monitoring device 10.

In a case where it is confirmed that the user has returned the book within the predetermined check-out time limit (for example, two hours), the processing returns to Step S302, and monitoring that is based on an input image from the monitoring device 10 is continued.

On the other hand, in a case where it is not confirmed that the user has returned the book within the predetermined check-out time limit (for example, two hours), the processing proceeds to Step S305.

(Step S305)

In a case where it is not confirmed in Step S304 that the user has returned the book within the predetermined check-out time limit (for example, two hours), the processing proceeds to Step S305.

In this case, in Step S305, the management server 20 executes warning output for prompting the user to return the book.

(Step S306a, b)

Step S306a, b is processing executed as a result of warning output executed by the management server 20 in Step S305.

Step S306a is warning output processing in the user terminal 50. Warning such as output of voice warning via the speaker of the user terminal 50, vibration warning, or displaying of a message on a screen is performed.

Furthermore, Step S306b is output of voice warning via the speaker being equipment of the monitoring device 10.

Note that it is only required that at least any of these outputs is executed.

The user who has confirmed any of these warnings recognizes the elapse of the check-out time limit of the book, and returns the book.

### 6-3. Processing Example 3

### Processing Example of Further Setting User Credit Rating Class that is Based on User Act in Processing Example 2

Next, a processing example of further setting a user credit rating class that is based on a user act in the processing example 2 will be described as a specific processing example 3.

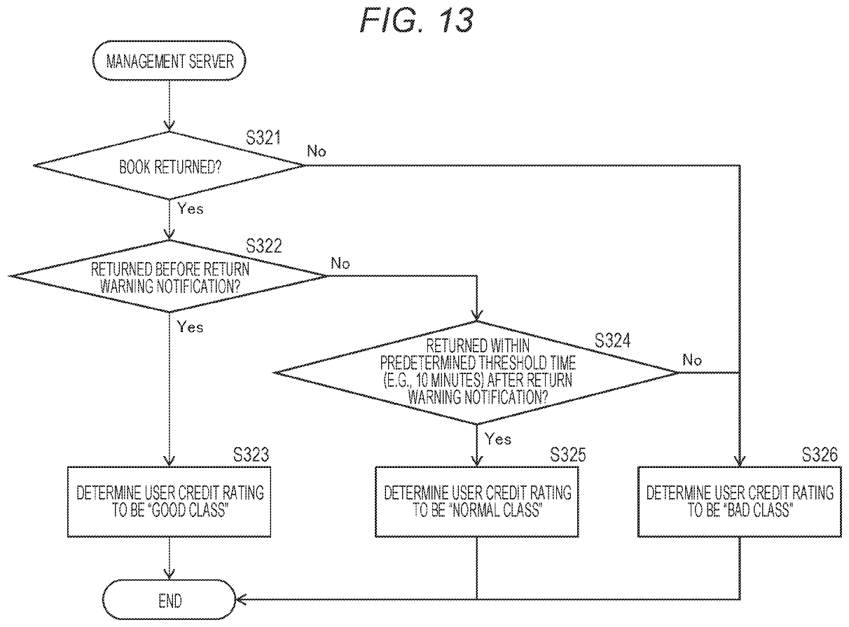

The flowchart illustrated in FIG. 13 is a flowchart describing a processing sequence of the processing example 3.

Note that the flow illustrated in FIG. 13 is processing executed together with the flow illustrated in FIG. 12, and is processing executed by the management server 20.

Hereinafter, processing in each step will be sequentially described.

(Step S321)

First of all, the management server 20 determines whether or not book return has been executed by the user. Note that the determination processing is executed on the basis of an image input from the monitoring device 10, which is not illustrated in the flow.

In a case where it is determined that book return has been executed by the user, the processing proceeds to Step S322.

On the other hand, in a case where it is determined that book return has not been executed by the user, the processing proceeds to Step S326.

(Step S322)

In a case where it is determined in Step S321 that book return has been executed by the user, the processing proceeds to Step S322.

In Step S322, the management server 20 determines whether or not the book has been returned by the user before warning notification of a return request to the user.

In a case where the book has been returned by the user before warning notification of a return request to the user, the processing proceeds to Step S323.

On the other hand, in a case where the book has been returned by the user after warning notification of a return request to the user, the processing proceeds to Step S324.

(Step S323)

In a case where the book has been returned by the user before warning notification of a return request to the user, in Step S323, the management server 20 determines a user credit rating to be “good class”, and performs update processing of user credit information stored in the storage unit 23. More specifically, as described above with reference to FIG. 7, user credit information update processing of rising a point of user credit information (1.0-0.0) is performed.

(Step S324)

On the other hand, in Step S322, in a case where the book has been returned by the user after warning notification of a return request to the user, in Step S324, the management server 20 determines whether or not the book has been returned by the user within a predetermined threshold time (for example, ten minutes) after the warning notification of the return request to the user.

In a case where the book has been returned by the user within a predetermined threshold time (for example, ten minutes) after the warning notification of the return request to the user, the processing proceeds to Step S325.

On the other hand, in a case where the book has been returned after a predetermined threshold time (for example, ten minutes), the processing proceeds to Step S326.

(Step S325)

In Step S324, in a case where the book has been returned by the user within a predetermined threshold time (for example, ten minutes) after the warning notification of the return request to the user, the management server 20 executes the processing in Step S325.

In Step S325, the management server 20 determines a user credit rating to be “normal class”. As described above with reference to FIG. 7, in this case, the management server 20 does not change a point of user credit information (1.0-0.0) that is stored in the storage unit 23.

(Step S326)

The processing in Step S326 is executed in the following two cases.

(a) In a case where it is determined in Step S321 that book return has not been executed by the user, or

(b) In a case where, in Step S324, the book has been returned by the user after a predetermined threshold time (for example, ten minutes) after the warning notification of the return request to the user,

in these case, the management server 20 executes the processing in Step S326.

In Step S326, the management server 20 determines a user credit rating to be “bad class”, and performs update processing of user credit information stored in the storage unit 23. More specifically, as described above with reference to FIG. 7, user credit information update processing of lowering a point of user credit information (1.0-0.0) is performed.

### 7. Usage of User Credit Information

As described above, by using the system of the present disclosure, the management server 20 can accumulate a large amount of user credit information by monitoring a user using a monitoring region.

A large amount of user credit information generated and updated by the management server 20 has various utility values.

Hereinafter, a usage example of user credit information generated by the management server 20 will be described.

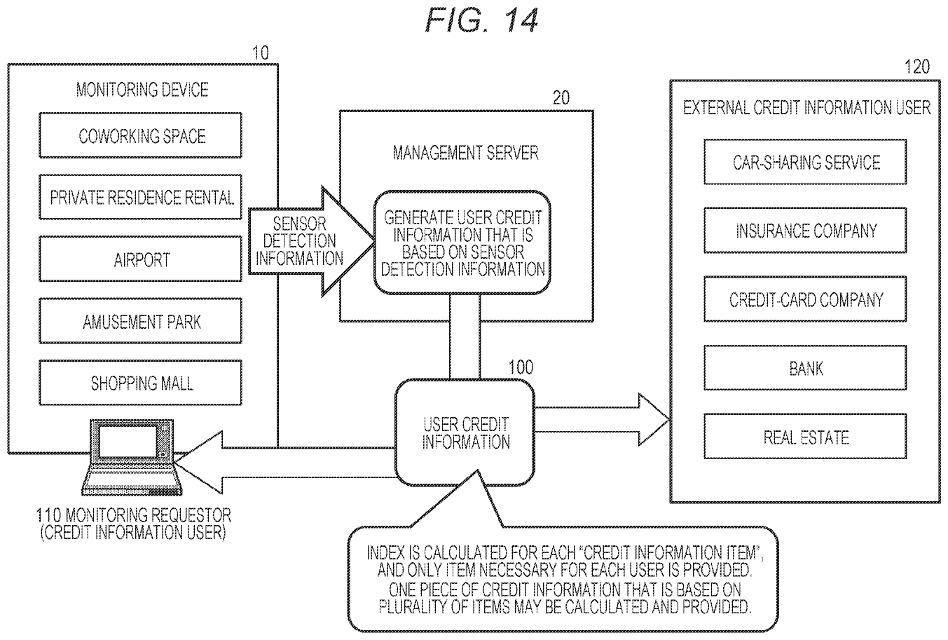

FIG. 14 is a diagram describing the overall configuration of generation of user credit information in the system of the present disclosure, and usage processing thereof.

The monitoring device 10 is set in various locations (monitoring regions) available to many users, such as a coworking space being a working place, private residence rental, an airport, an amusement park, or a shopping mall, for example.

Sensor detection information of the camera, the microphone, and the like of the monitoring device 10 is transmitted to the management server 20, and the management server 20 performs analysis of the sensor detection information, performs identification of the user who uses a monitoring region in which the monitoring device 10 is provided, and monitors a behavior of each of the identified users.

Moreover, the management server 20 sequentially generates and updates credit information of each of the users as a result of the monitoring processing.

The user credit information generated by the management server 20 is accumulated in the storage unit 23 of the management server 20.

As illustrated in the drawing, the management server 20 provides user credit information 100 stored in the storage unit 23, to a monitoring requestor 110, and further provides the user credit information 100 to the outside other than the monitoring requestor. The management server 20 provides the user credit information 100 to an external credit information user 120 illustrated in the drawing.

As illustrated in the drawing, the external credit information user 120 includes the following various companies, organization, and the like, for example.

(1) Car-sharing service provision company

(2) Insurance company

(3) Credit-card company

(4) Bank

(5) Real estate

When making a transaction with an individual, these companies and organizations need to confirm whether or not the individual is reliable.

As information for the confirmation, the credit information 100 generated by the management server 20 becomes available.

Note that user credit information generated by the management server 20 is partitioned into credit information for each of various items (credit information items) and categorized by the analysis processing of the management server 20.

The management server 20 provides credit information corresponding to an item requested by each credit information user. Alternatively, the management server 20 may be configured to calculate and provide one piece of credit information that is based on a plurality of items.

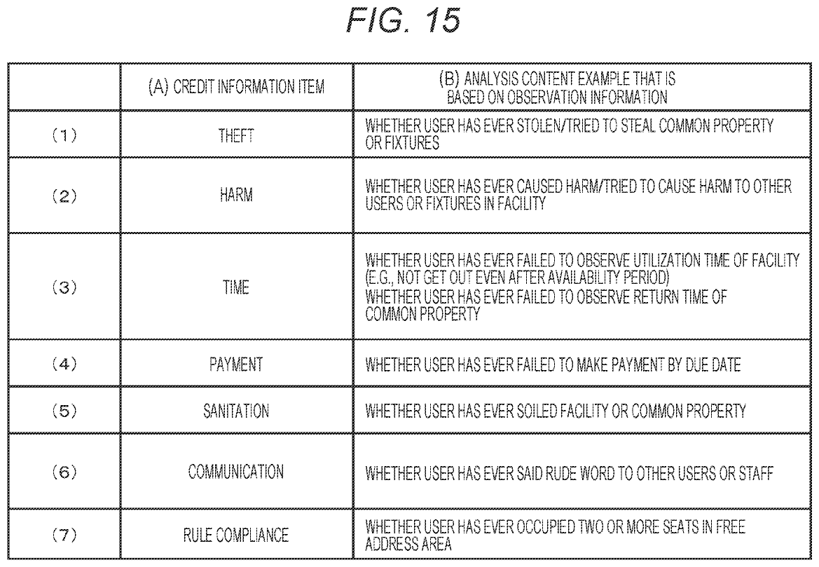

Examples of credit information items set on the basis of analysis of credit information that is executed by the management server 20 will be described with reference to FIG. 15.

FIG. 15 illustrates the following credit information items.

(1) Theft

(2) Harm

(3) Time

(4) Payment

(5) Sanitation

(6) Communication

(7) Rule compliance

The management server 20 calculates credit information (1.0-0.0) of each user for each of the above-described items by the analysis that is based on sensor (camera and the like) detection information of the monitoring device 10.

For example, as for (1) theft, for example, it is analyzed whether the user has ever stolen/tried to steal common property or fixtures, on the basis of the sensor detection information, and calculation and update processing of user credit information are executed on the basis of an analysis result.

As for (2) harm, for example, it is analyzed whether the user has ever caused harm/tried to cause harm to other users or fixtures in a facility, on the basis of the sensor detection information, and calculation and update processing of user credit information are executed on the basis of an analysis result.

As for (3) time, for example, it is analyzed whether the user has ever failed to observe a utilization time of a facility (e.g., not get out even after an availability period), or whether the user has ever failed to observe a return time of common property, on the basis of the sensor detection information, and calculation and update processing of user credit information are executed on the basis of an analysis result.

As for (4) payment, for example, it is analyzed whether the user has ever failed to make payment by due date, on the basis of the sensor detection information, and calculation and update processing of user credit information are executed on the basis of an analysis result.

As for (5) sanitation, for example, it is analyzed whether the user has ever soiled a facility or common property, on the basis of the sensor detection information, and calculation and update processing of user credit information are executed on the basis of an analysis result.

As for (6) communication, for example, it is analyzed whether the user has ever said a rude word to other users or staff, on the basis of the sensor detection information, and calculation and update processing of user credit information are executed on the basis of an analysis result.

As for (7) rule compliance, for example, it is analyzed whether the user has ever occupied two or more seats in a free address area of a coworking space where seats can be freely selected, on the basis of the sensor detection information, and calculation and update processing of user credit information are executed on the basis of an analysis result.

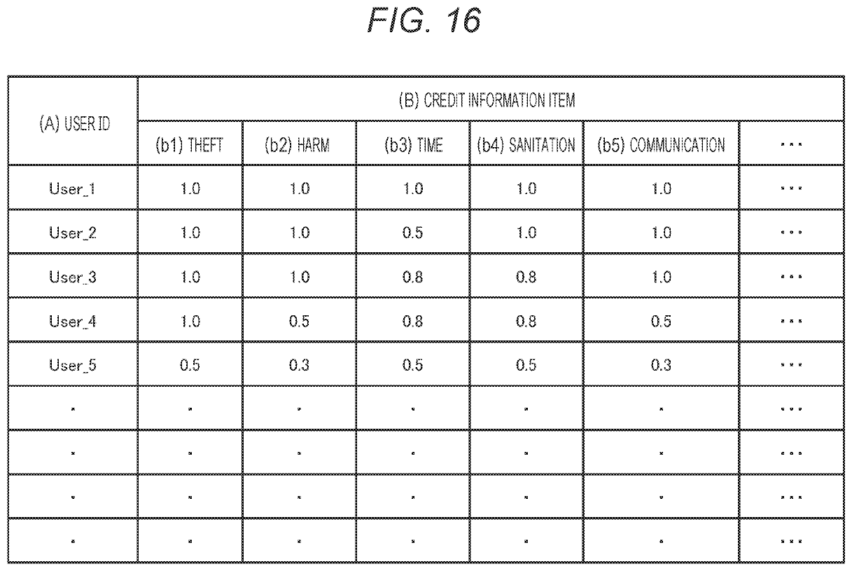

FIG. 16 illustrates an example of credit information calculated data for each user and for each credit information item that is generated by the management server 20 as a result of these types of analysis.

For example, credit information of a user 1 (User1) is as follows:

(b1) Theft=1.0

(b2) Harm=1.0

(b3) Time=1.0

(b4) Payment=1.0

(b5) Communication=1.0.

. . .

In all credit information items, the highest credit rating (1.0) is set, and the user 1 can be determined to be a user with a high credit rating.

On the other hand, credit information of a user 5 (User5) is as follows:

(b1) Theft=0.5

(b2) Harm=0.3

(b3) Time=0.5

(b4) Payment=0.5

(b5) Communication=0.3.

. . .

In all credit information items, a credit rating is low, and the user 5 can be determined to be a user with a low credit rating.

The management server 20 provides such credit information for each user and for each credit information item to a credit information user.

Note that, as described above with reference to FIG. 14, the credit information user includes companies, individuals, and organizations in various business categories, such as a bank, private residence rental, a real estate company, and a car-sharing service. Required credit information item varies depending on such a type of a credit information user.

Accordingly, the management server 20 performs processing of providing data corresponding to a credit information item suitable for a request of each user.

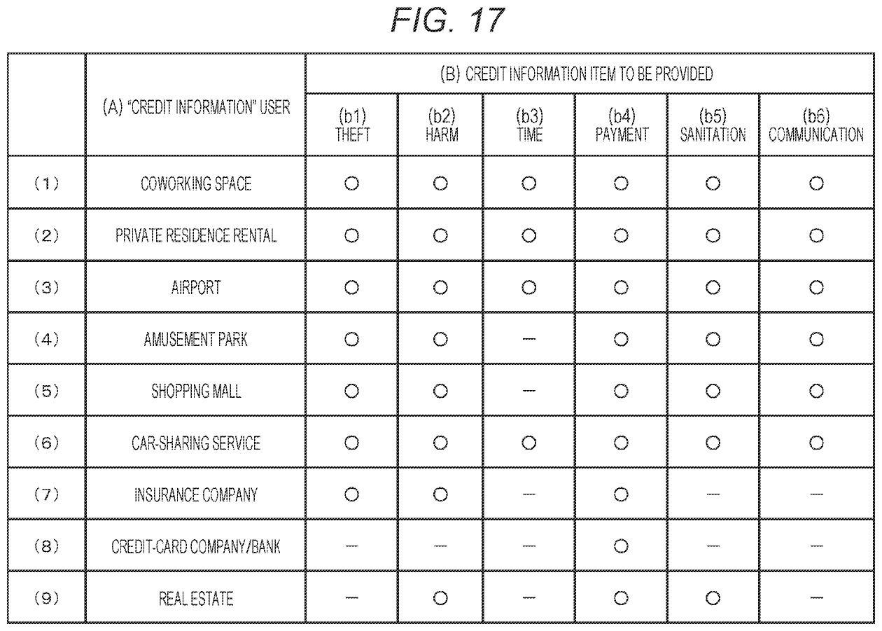

A selection provision example of a credit information item corresponding to a credit information user will be described with reference to FIG. 17. FIG. 17 illustrates an example of correspondence data of these:

(A) Credit information user

(B) Credit information item to be provided.

For example, credit information of each user corresponding to all of these items including (b) theft, (b2) harm, (b3) time, (b4) payment, (b5) sanitation, and (b6) communication is provided to companies, individuals, and organizations that manage (1) coworking space, (2) private residence rental, and (3) airport.

On the other hand, credit information of each user corresponding to these items including (b) theft, (b2) harm, (b4) payment, (b5) sanitation, and (b6) communication is provided to companies, individuals, and organizations that manage (4) amusement park and (5) shopping mall.

Furthermore, only credit information of each user corresponding to an item of (b4) payment is provided to (8) credit-card company and bank.

In this manner, the management server 20 performs processing of providing data corresponding to a credit information item suitable for a request of each user.

When executing a transaction with an individual with an unknown credit rating, companies, individuals, and organizations that receives provision of credit information from the management server 20 can confirm whether or not the individual is reliable, using the credit information received from the management server 20.

### 8. Hardware Configuration Example of Information Processing Device

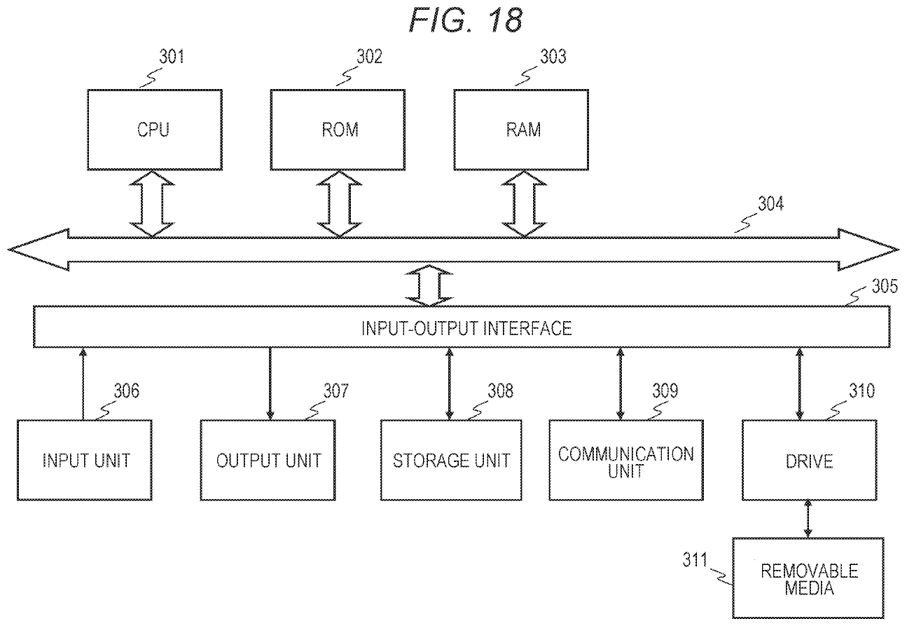

Next, a hardware configuration example of the monitoring device 10, the management server 20, the monitoring requestor terminal 40, and the user terminal 50, which are devices included in the information processing system of the present disclosure will be described with reference to FIG. 18.

Hardware to be described with reference to FIG. 18 illustrates an example of hardware that can be used as the monitoring device 10, the management server 20, the monitoring requestor terminal 40, and the user terminal 50, and each device needs not always have the same configuration as the configuration illustrated in FIG. 18.

Each component of the hardware configuration illustrated in FIG. 18 will be described.

A central processing unit (CPU) 301 functions as a data processing unit that executes various types of processing in accordance with programs stored in a read only memory (ROM) 302 or a storage unit 308. For example, processing is executed in accordance with the sequence described in the above-described embodiment. A random access memory (RAM) 303 stores programs to be executed by the CPU 301, data, and the like. The CPU 301, the ROM 302, and the RAM 303 are connected to each other via a bus 304.

The CPU 301 is connected to an input-output interface 305 via the bus 304. An input unit 306 including various switches, a keyboard, a touch panel, a mouse, a microphone, and the like, and an output unit 307 including a display, a speaker, and the like are connected to the input-output interface 305.

The storage unit 308 connected to the input-output interface 305 includes, for example, a hard disc, and the like, and stores programs to be executed by the CPU 301, and various types of data. A communication unit 309 functions as a transmission and reception unit of data communication via a network such as the internet or a local area network, and communicates with an external device.

A drive 310 connected to the input-output interface 305 drives a removable media 311 such as a semiconductor memory such as a magnetic disk, an optical disk, a magneto optical disk, or a memory card, and executes data recording or reading.

### 9. Conclusion of Configuration of Present Disclosure

Heretofore, the embodiments of the present disclosure have been described in detail with reference to specific embodiments. However, it is obvious that the one skilled in the art can modify or substitute the embodiment without departing from the scope of the present disclosure. In other words, the present invention has been disclosed in the form of exemplification, and is not to be construed in a limited way. For determining the scope of the present disclosure, the appended claims are to be referred to.

Note that the technology disclosed in this specification can also employ the following configurations.

(1) An information processing device including:

a data processing unit configured to analyze a user act on the basis of sensor detection information,

in which the data processing unit determines whether or not a user act falls under a violative act, and

in a case where it is determined that a user act is a violative act, the data processing unit performs notification of a warning.

(2) The information processing device according to (1),

in which the data processing unit executes at least any processing of warning notification to a user terminal owned by a user, or warning notification via a speaker near a user.

(3) The information processing device according to (1) or (2), in which the data processing unit determines entry to an entry forbidden region that is performed by the user, to be a violative act, and executes warning notification.

(4) The information processing device according to any of (1) to (3),

in which the data processing unit determines check-out of check-out forbidden goods that is performed by the user, to be a violative act, and executes warning notification.

(5) The information processing device according to any of (1) to (4),

in which the data processing unit executes user identification on the basis of sensor detection information, and

the data processing unit generates and updates credit information of each user that indicates a credit rating of a user, on the basis of an observation result of a user act of an identified user.

(6) The information processing device according to (5),

in which, in a case where a violative act performed by a user is observed, the data processing unit executes credit information update processing of lowering a credit rating of the user.

(7) The information processing device according to (5) or (6),

in which, in a case where a good act performed by a user is observed, the data processing unit executes credit information update processing of rising a credit rating of the user.

(8) The information processing device according to any of (5) to (7),

in which the data processing unit stores credit information of each user into a storage unit, and updates the credit information as needed.

(9) The information processing device according to any of (5) to (8),

in which the data processing unit executes processing of generating and updating credit information for each of a plurality of different credit information items, as credit information of each user, and storing the credit information into a storage unit.

(10) The information processing device according to any of (5) to (9),

in which the data processing unit inputs a feedback response from a user to warning notification, and executes revision of credit information that is based on the feedback response.

(11) An information processing system including:

a monitoring device configured to acquire detection information of a plurality of sensors provided in a monitoring region, and transmit the detection information to a management server;

a management server configured to receive sensor detection information from the monitoring device, and analyze a user act in the monitoring region on the basis of the received sensor detection information; and

a user terminal held by a user,

in which the management server determines whether or not a user act falls under a violative act, and

in a case where it is determined that a user act is a violative act, the management server notifies the user terminal or the monitoring device.

(12) The information processing system according to (11),

in which the management server determines entry to an entry forbidden region that is performed by the user, and check-out of check-out forbidden goods that is performed by the user, to be a violative act, and notifies the user terminal or the monitoring device.

(13) The information processing system according to (11) or (12),

in which the management server executes user identification on the basis of sensor detection information received from the monitoring device, and

the management server generates and updates credit information of each user that indicates a credit rating of a user, on the basis of an observation result of a user act of an identified user.

(14) The information processing system according to (13),

in which, in a case where a violative act performed by a user is observed, the management server executes credit information update processing of lowering a credit rating of the user, and

in a case where a good act performed by a user is observed, the management server executes credit information update processing of rising a credit rating of the user.

(15) An information processing method executed in an information processing device,

in which the information processing device includes a data processing unit configured to analyze a user act on the basis of sensor detection information,

the data processing unit determines whether or not a user act falls under a violative act, and

in a case where it is determined that a user act is a violative act, the data processing unit performs notification of a warning.

(16) An information processing method executed in an information processing system including a monitoring device, a management server, and a user terminal,

in which the monitoring device acquires detection information of a plurality of sensors provided in a monitoring region, and transmits the detection information to the management server,

the management server receives sensor detection information from the monitoring device, and determines whether or not a user act in the monitoring region falls under a violative act, on the basis of the received sensor detection information, and

in a case where it is determined that a user act is a violative act, the management server notifies the user terminal or the monitoring device.

(17) A program for causing an information processing device to execute information processing,

in which the information processing device includes a data processing unit configured to analyze a user act on the basis of sensor detection information, and

the program causes the data processing unit to execute

processing of determining whether or not a user act falls under a violative act, and

processing of performing notification of a warning in a case where it is determined that a user act is a violative act.

Note that a series of processes described in the specification can be executed by hardware, software, or a composite configuration of these. In a case where processing is executed by software, the processing can be executed by installing a program on which a processing sequence is recorded, onto a memory in a computer incorporated in dedicated hardware, or by installing a program onto a general-purpose computer that can execute various types of processing. For example, a program can be preliminarily recorded onto a recording medium. A program can be installed onto a recording medium such as a built-in hard disc, by receiving the program via a network such as a local area network (LAN) or the internet, instead of installing the program from a recording medium onto a computer.

Furthermore, various type of processing described in the specification may be concurrently or individually executed in accordance with processing capacity of a device that executes processing, or executed as necessary, instead of being chronologically executed in accordance with the described order. Furthermore, in this specification, a system refers to a logical aggregate configuration of a plurality of devices, and devices of configurations are not always provided in the same casing.

### INDUSTRIAL APPLICABILITY

As described above, according to a configuration of an embodiment of the present disclosure, a configuration of observing a user act in a monitoring region, performing detection of a violative act, and further generating credit information of each user is realized.

Specifically, for example, a monitoring device that acquires detection information of a sensor provided in a monitoring region, and transmits the detection information to a management server, the management server that analyzes a user act in the monitoring region on the basis of the sensor detection information, and a user terminal held by a user are included. The management server determines whether or not a user act falls under a violative act, and in a case where it is determined that a user act is a violative act, notifies the user terminal or the monitoring device. Moreover, the management server executes user identification, and generates and updates credit information of each user on the basis of an observation result of the user act of the identified user.

With this configuration, a configuration of observing a user act in a monitoring region, performing detection of a violative act, and further generating credit information of each user is realized.

### REFERENCE SIGNS LIST

10 Monitoring device
11 Camera
12 Receiver
13 Microphone
14 Speaker
15 Data processing unit
16 Communication unit
17 Storage unit
20 Management server
21 Data processing unit
22 Communication unit
23 Storage unit
31 Input signal (image, voice) processing unit
32 Human identification unit
33 Behavior monitoring unit
34 Object monitoring unit
35 User act (contact, entry, check-out, etc.) detection unit
36 Warning notification output control unit
37 Credit information generation update unit
40 Monitoring requestor terminal
41 Data processing unit
42 Input unit
43 Output unit
44 Communication unit
45 Storage unit
50 User terminal
51 Data processing unit
52 Input unit
53 Output unit
54 Communication unit
55 Storage unit
56 Vibration control unit
70 User
110 Monitoring requestor
120 External credit information user
301 CPU
302 ROM
303 RAM
304 Bus
305 Input-output interface
306 Input unit
307 Output unit
308 Storage unit
309 Communication unit
310 Drive
311 Removable media

1. An information processing device comprising:
a data processing unit configured to analyze a user act on a basis of sensor detection information,
wherein the data processing unit determines whether or not a user act falls under a violative act, and
in a case where it is determined that a user act is a violative act, the data processing unit performs notification of a warning.

2. The information processing device according to claim 1,
wherein the data processing unit executes at least any processing of warning notification to a user terminal owned by a user, or warning notification via a speaker near a user.

3. The information processing device according to claim 1,
wherein the data processing unit determines entry to an entry forbidden region that is performed by the user, to be a violative act, and executes warning notification.

4. The information processing device according to claim 1,
wherein the data processing unit determines check-out of check-out forbidden goods that is performed by the user, to be a violative act, and executes warning notification.

5. The information processing device according to claim 1,
wherein the data processing unit executes user identification on a basis of sensor detection information, and
the data processing unit generates and updates credit information of each user that indicates a credit rating of a user, on a basis of an observation result of a user act of an identified user.

6. The information processing device according to claim 5,
wherein, in a case where a violative act performed by a user is observed, the data processing unit executes credit information update processing of lowering a credit rating of the user.

7. The information processing device according to claim 5,
wherein, in a case where a good act performed by a user is observed, the data processing unit executes credit information update processing of rising a credit rating of the user.

8. The information processing device according to claim 5,
wherein the data processing unit stores credit information of each user into a storage unit, and updates the credit information as needed.

9. The information processing device according to claim 5,
wherein the data processing unit executes processing of generating and updating credit information for each of a plurality of different credit information items, as credit information of each user, and storing the credit information into a storage unit.

10. The information processing device according to claim 5,
wherein the data processing unit inputs a feedback response from a user to warning notification, and executes revision of credit information that is based on the feedback response.

11. An information processing system comprising:
a monitoring device configured to acquire detection information of a plurality of sensors provided in a monitoring region, and transmit the detection information to a management server;
a management server configured to receive sensor detection information from the monitoring device, and analyze a user act in the monitoring region on a basis of the received sensor detection information; and
a user terminal held by a user,
wherein the management server determines whether or not a user act falls under a violative act, and
in a case where it is determined that a user act is a violative act, the management server notifies the user terminal or the monitoring device.

12. The information processing system according to claim 11,
wherein the management server determines entry to an entry forbidden region that is performed by the user, and check-out of check-out forbidden goods that is performed by the user, to be a violative act, and notifies the user terminal or the monitoring device.

13. The information processing system according to claim 11,
wherein the management server executes user identification on a basis of sensor detection information received from the monitoring device, and
the management server generates and updates credit information of each user that indicates a credit rating of a user, on a basis of an observation result of a user act of an identified user.

14. The information processing system according to claim 13,
wherein, in a case where a violative act performed by a user is observed, the management server executes credit information update processing of lowering a credit rating of the user, and
in a case where a good act performed by a user is observed, the management server executes credit information update processing of rising a credit rating of the user.

15. An information processing method executed in an information processing device,
wherein the information processing device includes a data processing unit configured to analyze a user act on a basis of sensor detection information,
the data processing unit determines whether or not a user act falls under a violative act, and
in a case where it is determined that a user act is a violative act, the data processing unit performs notification of a warning.

16. An information processing method executed in an information processing system including a monitoring device, a management server, and a user terminal,
wherein the monitoring device acquires detection information of a plurality of sensors provided in a monitoring region, and transmits the detection information to the management server,
the management server receives sensor detection information from the monitoring device, and determines whether or not a user act in the monitoring region falls under a violative act, on a basis of the received sensor detection information, and
in a case where it is determined that a user act is a violative act, the management server notifies the user terminal or the monitoring device.

17. A program for causing an information processing device to execute information processing,
wherein the information processing device includes a data processing unit configured to analyze a user act on a basis of sensor detection information, and
the program causes the data processing unit to execute
processing of determining whether or not a user act falls under a violative act, and
processing of performing notification of a warning in a case where it is determined that a user act is a violative act.
